(19) United States
(12) Patent Application Publication
(10) Pub. No.: US 2013/0240681 A1
(43) Pub. Date: Sep. 19, 2013

(54) CONDUIT TRAY, CAM CONNECTOR AND ASSOCIATED METHODS

(71) Applicant: ENDURO COMPOSITES, INC., Houston, TX (US)

(72) Inventor: Wallace Sanford Woodlief, Houston, TX (US)

(73) Assignee: ENDURO COMPOSITES, INC., Houston, TX (US)

(21) Appl. No.: 13/826,576

(22) Filed: Mar. 14, 2013

Related U.S. Application Data
(60) Provisional application No. 61/611,919, filed on Mar. 16, 2012.

(51) Int. Cl. F16L 3/26; F16B 17/00

(52) U.S. Cl. CPC F16L 3/26; F16B 17/00
USPC 248/49; 248/300; 403/350; 29/428

(57) ABSTRACT

An embodiment of the present invention provides a conduit tray that supports various types of conduits. A plurality of cam rungs are positioned within C-channels of the brace members of the conduit tray. Alternative embodiments of the present invention include a brace to retain a cam body member, a cam member to mate with a brace, a cam connector to matingly connect a member therein, a brace and rung structure, and associated methods.

### CROSS-REFERENCE TO RELATED APPLICATIONS

The present application is a non-provisional of, and claims the benefit of, U.S. Provisional Patent Application 61/611,919, filed Mar. 16, 2012.

### BACKGROUND

1. Field of the Invention

Embodiments of the present invention relate to the conduit industries and, more particularly, brace members to support conduits, connecting members, and methods relating thereto.

2. Related Art

Structural systems with various assembled support members, such as cable trays for carrying cables, wires, tubing, piping, or other conduits, are well known. The support members of such systems have generally been preformed as a u-shaped channel, welded or pinned, connected with the use of adhesive, or some combination of these methods. Such systems may require extensive labor to make up in the field, especially where custom fitting is required. Alternatively, the support system may be required to be prefabricated at a remote location before being shipped to the field, leading to increased shipping costs as well as increasing the probability that the system will not properly fit within the space allotted at the installation site.

### SUMMARY OF THE INVENTION

In view of the foregoing, Applicant recognized that there is a need for support and connector members that can be efficiently assembled on site with simple tools, as well as a method for such assembly. Such an invention would reduce shipping costs and labor costs. In addition, such an invention would allow the installers to custom fit the connector parts to the space available at the site rather than attempting to build the structure ahead of time at a remote location and increasing the risk that the product would not fit within the required space. This in turn reduces refitting time and costs.

Applicant further recognized use of adhesive to bond members is undesirable. Applicant therefore recognized a need to develop improved support and connector members and assembly methods that also eliminates or reduces the need for adhesives. Embodiments, however, are not limited to implementations offering all of these advantages, as various engineering and cost tradeoffs are envisioned.

The disclosed invention includes embodiments relating to conduit trays that support various types of conduits, embodiments that include a brace to retain a cam-shaped member, embodiments that include a cam member to mate with a brace, embodiments that include a connector with a earn-shaped portion, embodiments relating to brace and rung structures, and embodiments that include associated methods of assembly and manufacture.

In one embodiment, a conduit tray to support conduits is disclosed. The conduit tray has a first brace member having a substantially overall E-shape, which may be referred to as a first E-beam. A second brace member of the conduit tray may also be an E-beam. The second E-beam is positioned spaced apart and facing an opposite direction as the first E-beam, so that lower surfaces of a lowermost leg member of each the first and second E-beams is positioned in substantially the same plane. Collectively, the first and second E-beams may be called a conduit tray brace.

In some embodiments of the conduit tray, each of the E-beams include an elongated web member defining an E-beam body. An uppermost leg member is connected to, extending substantially perpendicular to, and extending inwardly from an upper end portion of the E-beam body toward an opposite facing E-beam body. In other embodiments, no uppermost leg member is required and the shape of the beam instead resembles an inverted F than an E, which is not to suggest that other features may not also be omitted in some embodiments.

In some embodiments, the lowermost leg member is connected to, extending substantially perpendicular to, and extending inwardly from a lower end portion of the E-beam body toward an opposite facing E-beam body. The lowermost leg member has substantially the same width as the uppermost leg member and extends in a substantially similar direction as and substantially parallel to the uppermost leg member. An upward extending lip extends upward from a medial portion of the lowermost leg member. The upward extending lip has an outward facing surface, and extends substantially the length of the lowermost leg member. The lowermost leg member may further include a portion extending inward of the upward extending lip to thereby define a lower ledge.

An embodiment of a conduit tray may also include a middle leg member connected to, extending substantially perpendicular to, and extending inwardly from a medial portion of the F-beam body in a location between the uppermost and lowermost leg members. The middle leg member may be in a plane closer to the plane of the lowermost leg than the plane of the uppermost leg and have a width less than the width of the uppermost and lowermost leg members. The middle leg member may extend in a substantially similar direction as and substantially parallel to each of the uppermost and lowermost leg members. A downward extending lip may extend downward from a distal end portion of the middle leg member toward the lowermost leg member. The downward facing lip has an outward facing surface, and extends substantially the length of the middle leg member, so that interstitial space located between outward surfaces of the upward extending tip and the downward extending lip, portions of the middle leg member, portions of the lowermost leg member, and inward facing portions of the E-beam body extending therebetween have a substantially C-shape. The interstitial space extends substantially the length of the E-beam to thereby define a C-channel.

An embodiment of a conduit tray may additionally include a plurality of cam rungs, each spaced apart from another cam rung, having respective opposite end portions connectively positioned in each respective C-channel of the first and second E-beams. The cam rungs extend between each of the E-beams, so that an inward facing surface of each of the first E-beam and second E-beam and an upward facing portion of each cam rung form a substantially U shape to define a conduit cavity. When conduit is positioned in the conduit tray the conduit is contained within the conduit cavity.

Each cam rung of an embodiment of the conduit tray many have an elongated rung body member. The elongated body member may have a first end portion that includes a first end and a head member extending inwardly from the first end toward the rung body member to define a first cam section. A first circumferential groove spaced apart from, and proximal to, the first end, is formed in the rung body member. The first circumferential groove defines an inward boundary of the first cam section and the first end defines an outward boundary of the first cam section. The first groove has a width substantially similar to the each of the widths of the upward extending and downward extending lips of the C-channel of the first E-beam. The first groove is positioned to contactingly engage the upper extending and downward extending lips of the C-channel of the first E-beam.

In some embodiments, a second end portion of the elongated rung body includes a second end positioned opposite to the first end and extending inwardly from the second end toward the rung body member. The second end defines an outward boundary of the second cam section. A second circumferential groove is spaced apart from, but proximal to the second end and the second cam section, formed in the rung body member. The second circumferential groove defines an inward boundary of the second cam section. The second groove also has a width substantially similar to each of the widths of the upward extending and downward extending lips of the C-channel of the second E-beam and is positioned to contactingly engage the upper extending and downward extending lips of the C-channel of the second E-beam.

Each of the first and second cam sections may have a width substantially similar to the distance between the outward facing surfaces of the lips and the inward facing portions of the E-beam body. Each of the first and second cam sections may also have a height substantially similar to the distance between an upper surface of the lower lowermost leg member and a lower surface of the middle leg member of the E-beam body so that each of the first and second cam sections matingly connect to and are retained within a respective C-channel of the first and second E-beams to connectively support the cam rung to the C-channel within the conduit tray brace.

In an alternative embodiment, a brace to retain a cam body member includes a brace member having an elongated web member defining a beam body. The can body member may be, for example, a cam rung. A lowermost leg member may be connected to, extend substantially perpendicular to, and extend inwardly from a lower end portion of the beam body. The lowermost leg member may extend substantially the length of the beam body. An upward extending lip may extend upward from a medial portion of the lowermost leg member, extending substantially the length of the lowermost leg member.

A middle leg member may be connected to, extend substantially perpendicular to, and extend inwardly from a medial portion of the beam body in a location above the lowermost leg member. The middle leg member may extend substantially the length of the beam body, have a width less than a width of the lowermost leg member, and extend in a substantially similar direction as lowermost leg members, so that the extent of the middle leg member is substantially parallel to the lowermost leg member. A downward extending lip may extend downward from a distal end portion of the middle leg member toward the lowermost leg member. The downward extending lip may extend substantially the length of the middle leg member, so that interstitial space located between surfaces of the upward extending lip and the downward extending lip, portions of the middle leg member, portions of the lowermost leg member, and portions of the beam body extending therebetween have a substantially C-shape. The interstitial space may extend substantially the length of the E-beam body to define a C-channel.

In another alternative embodiment, a cam member to mate with a brace includes a cam body member having an end. A circumferential groove is formed in the cam body member and is located proximal to the end to engage a portion of a brace. The cam body member also has an end portion that can be matingly positioned within a portion of the brace. The end portion extends inwardly from the end toward the rung body member to define a cam section. The end defines an outward boundary of the cam section, and the circumferential groove defines an inward boundary of the cam section. The cam section includes a top end, a bottom end, a first side surface, and a second side surface. The first side surface is opposite and substantially parallel to the second side surface. The bottom end comprises a plurality of surfaces on different planes and meets the first side surface at an interior angle greater than 90 degrees. The top end comprises a plurality of surfaces on different planes and meets the second side surface at an interior angle greater than 90 degrees.

In yet another alternative embodiment, a cam connector includes both a cam member and a brace member, the brace member having a brace body. The brace member has a lowermost leg member connected to, extending substantially perpendicular to, and extending from a lower end portion of the brace body. An upward extending lip extends upward from a medial portion of the lowermost leg member. A middle leg member may be connected to, extend substantially perpendicular to, and extend from a medial portion of the brace body in a location above the lowermost leg member. The middle leg member extends in a substantially similar direction as lowermost leg member so that the extent of the middle leg member is substantially parallel to the lowermost leg member. A downward extending lip extends downward from a distal end portion of the middle leg member toward the lowermost leg member, so that interstitial space located between surfaces of the upward extending lip and the downward extending lip, portions of the middle leg member, portions of the lowermost leg member, and portions of the beam body extending therebetween have a substantially C-shape to thereby define a C-channel.

A cam member to mate with the brace member may include a cam body member having an end. A circumferential groove may be formed in the cam body member and located proximal to the end to engage a portion of a brace. An end portion of the cam body can be matingly positioned within a portion of the brace. The end portion extends inwardly from the end toward the rung body member to define a cam section. The end defines an outward boundary of the cam section, and the circumferential groove defines an inward boundary of the cam section.

The cam section includes a top end, a bottom end, a first side surface, and a second side surface. The first side surface is opposite and substantially parallel to the second side surface. The bottom end comprises a plurality of surfaces on different planes and meets the first side surface at an interior angle greater than 90 degrees. The top end comprises a plurality of surfaces on different planes and meets the second side surface at an interior angle greater than 90 degrees. The cam section substantially fills an interstitial space within the C-channel of the brace, and portions of the top end, bottom end, first side surface, and second side surface of the cam section contact surfaces within the C-channel.

In other embodiments, a brace and rung structure includes a first brace member and a second brace member, the second brace member being positioned spaced apart and facing an opposite direction of the first brace member. The brace members include a web member defining a brace body. A lowermost leg member is connected to, extends substantially perpendicular to, and extends inwardly from a lower end portion of the brace body. An upward extending lip may extend upward from the lowermost leg member.

A middle leg member may be connected to, extend substantially perpendicular to, and extend inwardly from a medial portion of the brace body in a location above the lowermost leg member. A downward extending lip may extend downward from a distal end portion of the middle leg member toward the lowermost leg member, so that interstitial space located between surfaces of the upward extending lip and the downward extending lip, portions of the middle leg member, portions of the lowermost leg member, and portions of the E-beam body extending therebetween have a substantially C-shape to define a C-channel.

In some embodiments, a cam rung is connected to and extends between each of the brace members. Each of the cam rungs includes an elongated rung body member. Each of the at least one cam rungs may also include a first end portion with a first end. A head member extends inwardly from the first end toward the rung body member to define a first cam section. The first end defines an outward boundary of the first cam section, and a first circumferential groove spaced apart from, proximal to the first end and the first cam section, formed in the rung body member, defines an inward boundary of the first cam section. The first groove is positioned to contactingly engage the upper extending and downward extending lips of the C-channel of the first brace member.

The cam rungs may also have a second end portion with a second end positioned substantially opposite to the first end and extending inwardly from the second end toward the rung body member to define a second cam section. The second end defines an outward boundary of the second cam section, and a second circumferential groove spaced apart from, proximal to the second end and the second cam section, formed in the rung body member, defines an inward boundary of the second cam section. The second groove is positioned to contactingly engage the upper extending and downward extending lips of the C-channel of the second brace member.

In alternative embodiments, a method of assembling a rung interface includes providing a brace member. The brace member has a web portion defining a brace body, and a lowermost leg member connected to, extending substantially perpendicular to, and extending inwardly from a lower end portion of the brace body, extending substantially the length of the brace body. An upward extending lip extends upward from a medial portion of the lowermost leg member, having an outward facing surface, and extending substantially the length of the lowermost leg member. A middle leg member is connected to, extends substantially perpendicular to, and extends inwardly from the brace body in a location above the lowermost leg member, extending substantially the length of the brace body. The middle leg member has a width less than the width of the lowermost leg member and extends in a substantially similar direction as the lowermost leg member so that the extent of the middle leg member is substantially parallel to the extent of the lowermost leg member. A downward extending lip extends downward from a distal end portion of the middle leg member toward the lowermost leg member. The downward extending lip has an outward facing surface, and extends substantially the length of the middle leg member, so that interstitial space located between outward surfaces of the upward extending lip and the downward extending lip, portions of the middle leg member, portions of the lowermost leg member, and an inward facing portions of the brace body extending therebetween has a substantially C-shape. The interstitial space extends substantially the length of the brace member to thereby define a C-channel.

The method of an alternative embodiment also includes positioning an end portion of a rung body member between the downward extending lip and the upward extending lip within the C-channel such that an end surface of the rung body abuttingly contacts an inward facing portion of the brace body and the end portion of the body member is located within the C-channel in an unsupported position.

The method may further include rotating the rung body member such that a circumferential groove formed in the rung body member and located proximal to a rung end of the rung body member matingly engages the downward extending lip and upward extending lip of the beam. The end portion of the rung body proximal to the rung end extends outwardly from the circumferential groove, defining a cam section of the rung body such that the cam section of the rung body member is in a supported position within the C-channel;

### BRIEF DESCRIPTION OF DRAWINGS

So that the manner in which the features and benefits of the invention, as well as others which will become apparent, may be understood in more detail, a more particular description of the invention, aspects of which are briefly summarized above, may be had by reference to the embodiments thereof that are illustrated in the appended drawings, which form a part of this specification. It is also to be noted, however, that the drawings illustrate only various embodiments of the invention and are therefore not to be considered limiting of the inventions scope as it may include other effective embodiments as well.

FIG. 1A is a perspective environmental view of a conduit tray according to an embodiment of the present invention;

FIG. 1B is another perspective environmental view of a conduit tray according to an embodiment of the present invention;

FIG. 2A is a perspective view of a conduit tray according to an embodiment of the present invention;

FIG. 2B is a perspective view of a portion of a conduit tray according to an embodiment of the present invention;

FIG. 2C is a detail sectional view of a portion of a conduit tray according to an embodiment of the present invention;

FIG. 2D is a front view of the conduit tray according to an embodiment of the present invention;

FIG. 2E is a side view of the conduit tray according to an embodiment of the present invention;

FIG. 2F is a detail sectional side view of the end portion of a cam rung according to an embodiment of the present invention;

FIG. 3 is an exploded perspective view of a of a conduit tray according to an embodiment of the present invention;

FIG. 4A is a cross sectional detail view of an end portion of a cam rung being inserted into a support member according to an embodiment of the present invention;

FIG. 4B is a perspective detail view of an end portion of a cam rung inserted into a support member according to an embodiment of the present invention;

FIG. 4C is a perspective detail view of a tool turning a cam rung to a supported position within a support member according to an embodiment of the present invention;

FIG. 4D is a perspective detail view of a drop out being mounted on a cam rung according to an embodiment of a conduit tray of the present invention;

FIG. 4E is a perspective detail view of a drop out mounted on a cam rung according to an embodiment of the present invention;

FIG. 5A is a front elevational view of a conduit tray according to an embodiment of the present invention;

FIG. 5B is a left side elevational view of a conduit tray with lock notches according to an embodiment of the present invention;

FIG. 5C is a right side elevational view of a conduit tray with lock notches according to an embodiment of the present invention;

FIG. 5D is a top plan view of a conduit tray with lock notches according to an embodiment of the present invention;

FIG. 5E is a bottom plan view of a conduit tray with lock notches according to an embodiment of the present invention;

FIG. 6A is a perspective view of a cam rung according to an embodiment of the present invention;

FIG. 6B is a front elevational view of a rung according to an embodiment of the present invention;

FIG. 6C is a rear elevational view of a rung according to an embodiment of the present invention;

FIG. 6D is a left side elevational view of a rung according to an embodiment of the present invention;

FIG. 6E is a right side elevational view of a rung according to an embodiment of the present invention;

FIG. 6F is a top plan view of a rung according to an embodiment of the present invention;

FIG. 6G is a bottom plan view of a rung according to an embodiment of the present invention;

FIG. 7A is a perspective view of a brace with lock notches according to an embodiment of the present invention;

FIG. 7B is a front elevational view of a brace with lock notches according to an embodiment of the present invention;

FIG. 7C is a left side elevational view of a brace with lock notches according to an embodiment of the present invention;

FIG. 7D is a right side elevational view of a brace with lock notches according to an embodiment of the present invention;

FIG. 7E is a top plan view of a brace with lock notches according to an embodiment of the present invention;

FIG. 7F is a bottom plan view of a brace with lock notches according to an embodiment of the present invention;

FIG. 7G is a detail sectional view a brace according to an embodiment of the present invention;

FIG. 7H is a perspective view of a portion of a brace according to an embodiment of the present invention;

FIG. 8 is an environmental view of a conduit tray according to an embodiment of the present invention;

FIG. 9A is a perspective view of a conduit tray according to an embodiment of the present invention;

FIG. 9B is a perspective view of the end portion of a cam rung according to an embodiment of the present invention;

FIG. 9C is a detail sectional view of the end portion of a cam rung according to an embodiment of the present invention;

FIG. 9D is a front view of the conduit tray according to an embodiment of the present invention;

FIG. 9E is a side view of the conduit tray according to an embodiment of the present invention;

FIG. 9F is a detail sectional side view of the end portion of a cam rung according to an embodiment of the present invention;

FIG. 10A is a perspective view of a conduit tray according to an embodiment of the present invention;

FIG. 10B is a perspective view of a conduit tray according to an embodiment of the present invention;

FIG. 10C is a side elevational view of a conduit tray according to an embodiment of the present invention;

FIG. 10D is a front view of the conduit tray according to an embodiment of the present invention;

FIG. 10E is a detail sectional side view of the end portion of a cam rung according to an embodiment of the present invention;

FIG. 10F is a detail sectional view of a portion of a conduit tray according to an embodiment of the present invention;

FIG. 10G is a perspective view of a cam member according to an embodiment of the present invention;

FIG. 10H is a perspective view of a portion of a cam member according to an embodiment of the present invention;

FIG. 11A is a perspective view of a drop out positioned on a rung of a conduit tray according to an embodiment of the present invention;

FIG. 11B is a sectional view of a drop out positioned on a rung of a conduit tray according to an embodiment of the present invention;

FIG. 11C is a top plan view of a drop out positioned on a rung of a conduit tray according to an embodiment of the present invention;

FIG. 12A is a perspective view of a drop out according to an embodiment of the present invention;

FIG. 12B is a perspective view of a drop out according to an embodiment of the present invention;

FIG. 12C is a front elevational view of a drop out according to an embodiment of the present invention;

FIG. 12D is a left side elevational view of a drop out according to an embodiment of the present invention;

FIG. 12E is a right side elevational view of a drop out according to an embodiment of the present invention;

FIG. 12F is a top plan view of a drop out according to an embodiment of the present invention; and

FIG. 12G is a bottom plan view of a drop out according to an embodiment of the present invention.

### DETAILED DESCRIPTION

The present invention will now be described more fully hereinafter with reference to the accompanying drawings, which illustrate various embodiments of the invention. This invention, however, may be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

Applicants recognized a need for support and connector members that can be efficiently assembled on site with simple tools, as well as a method for such assembly. Applicant additionally recognized a need to develop improved support and connector members, and a method of assembly, that also eliminates or reduces the need for adhesives. As will be understood by those skilled in the art, in some embodiments, a support system of braces and cam rungs can be made up with a separate tool on site. It should be noted, though, embodiments are not limited to implementations providing all of these benefits, as various engineering and cost tradeoffs are envisioned.

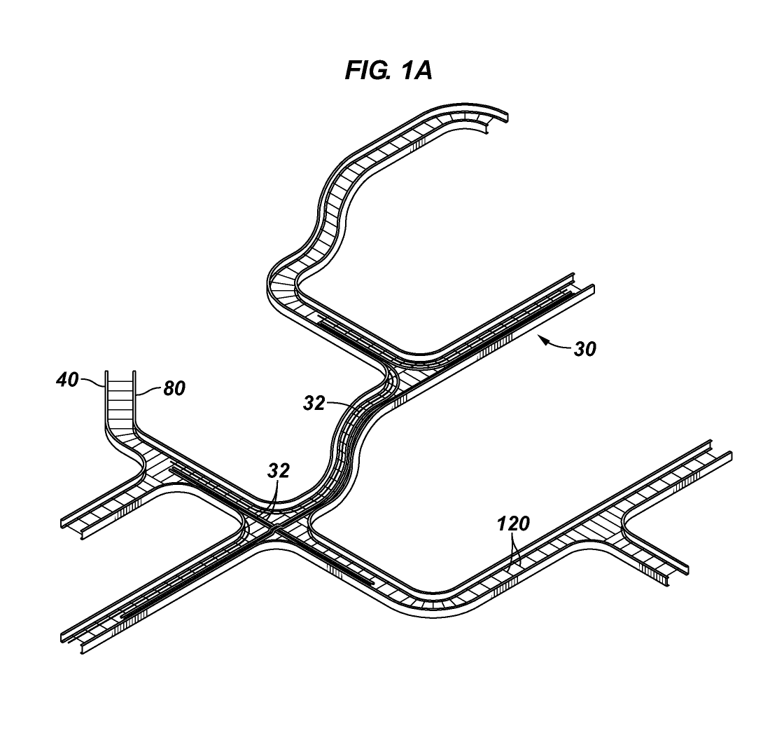

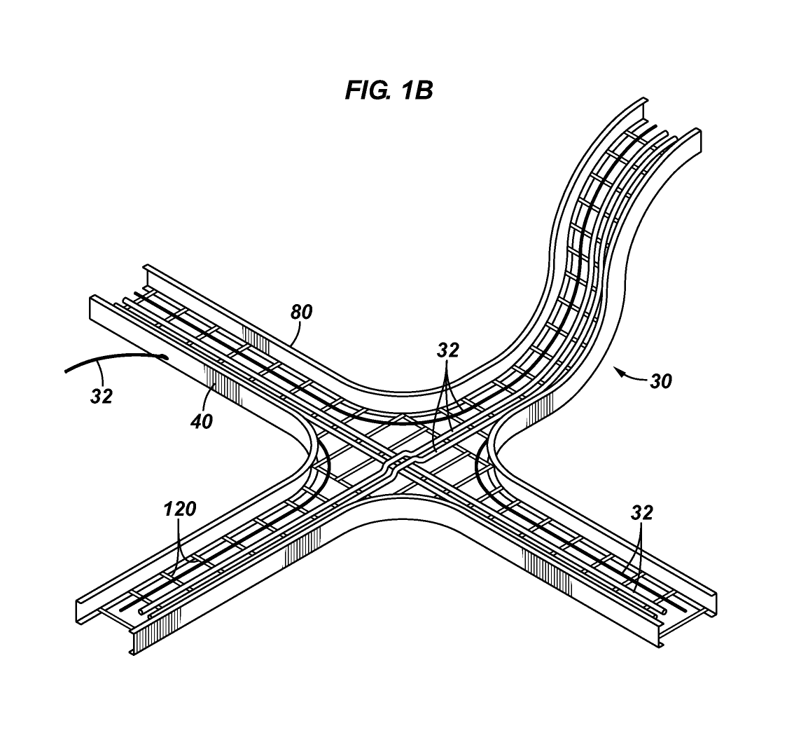

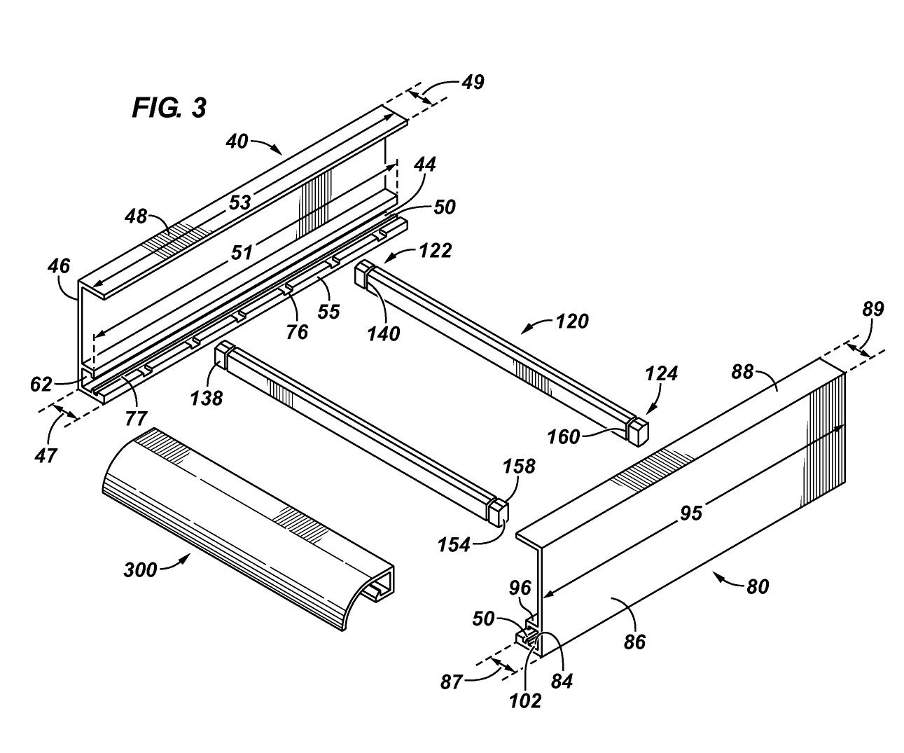

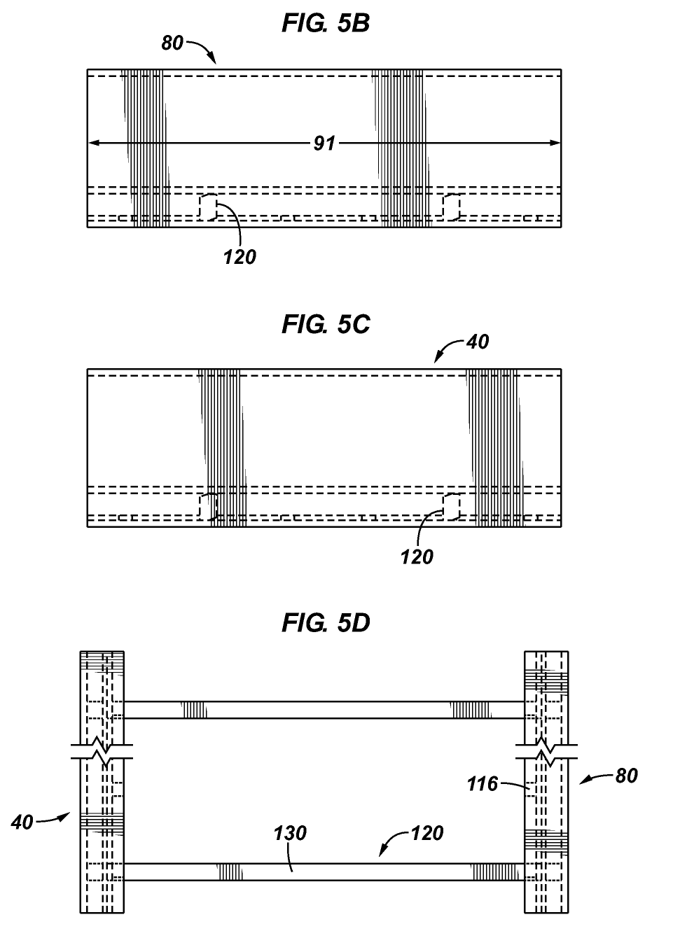

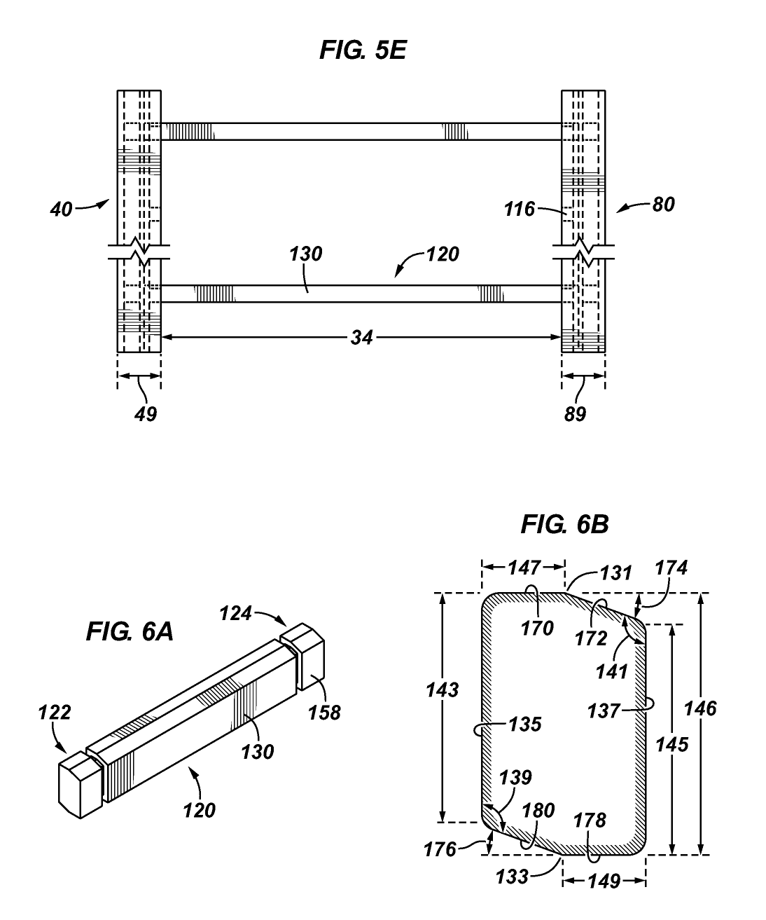

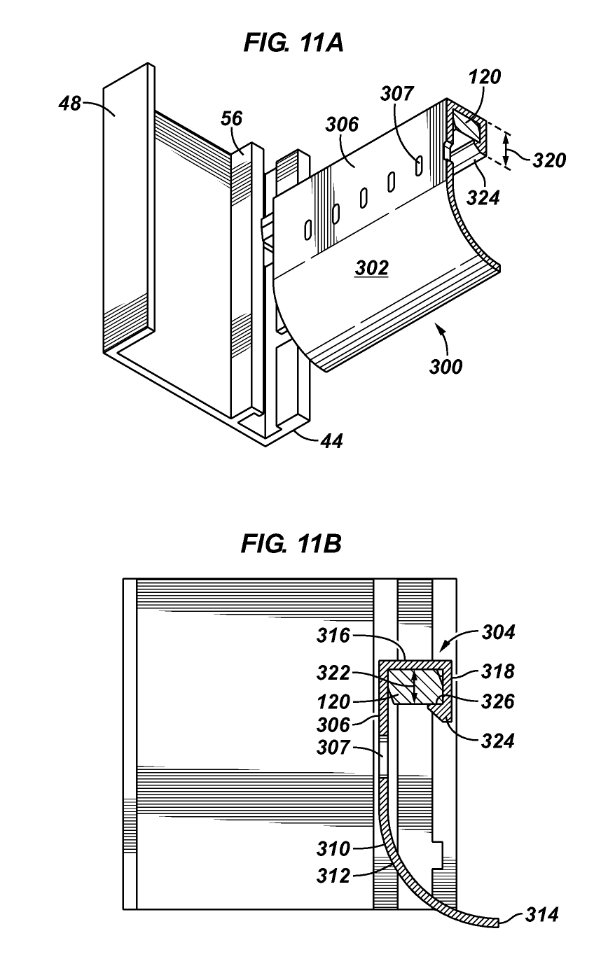

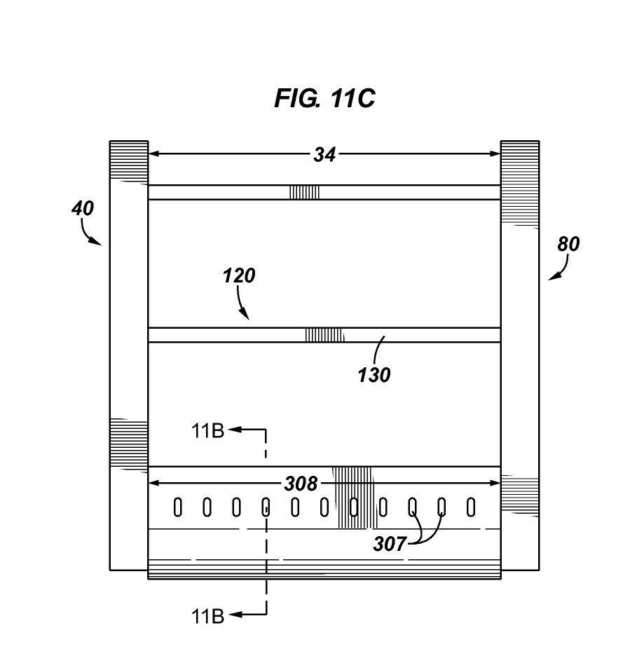

As shown in FIGS. 1 through 5 and 9 through 11, according to an embodiment of the present invention, an example of a brace and rung structure 30 may be a conduit tray to support conduits 32. Conduits 32 may be, for example, cables, wires, tubing, piping, or other elongated components. Conduit tray 30 may be installed, for example, in a building, on a platform, or in another type of structure and, as such, may assume a variety of different shapes in accordance with the surrounding structure by assembling the component embodiments described herein to accommodate such structures. Conduit tray 30 may include a first brace member 40, having a substantially overall E-shape to define a first E-beam. The conduit tray 30 has a second brace member 80. The second brace member 80 also has a substantially overall E-shape to define a second E-beam. The second E-beam 80 is positioned spaced apart and facing an opposite direction as the first E-beam 40, so that lower surfaces 42, 82 of a lowermost leg member 44, 84 of each the first and second E-beams 40, 80 is positioned in substantially the same plane. The E-beams 40, 80 are therefore situated as mirror images of each other with the lowermost leg members 44, 84 of the F-beams 40, 80 extending towards each other. Collectively the first and second E-beams 40, 80 define a conduit tray brace 34. The distance between the first and second E-beams 40, 80, will be tailored to suit the site and application for which the conduit tray 30 is being used.

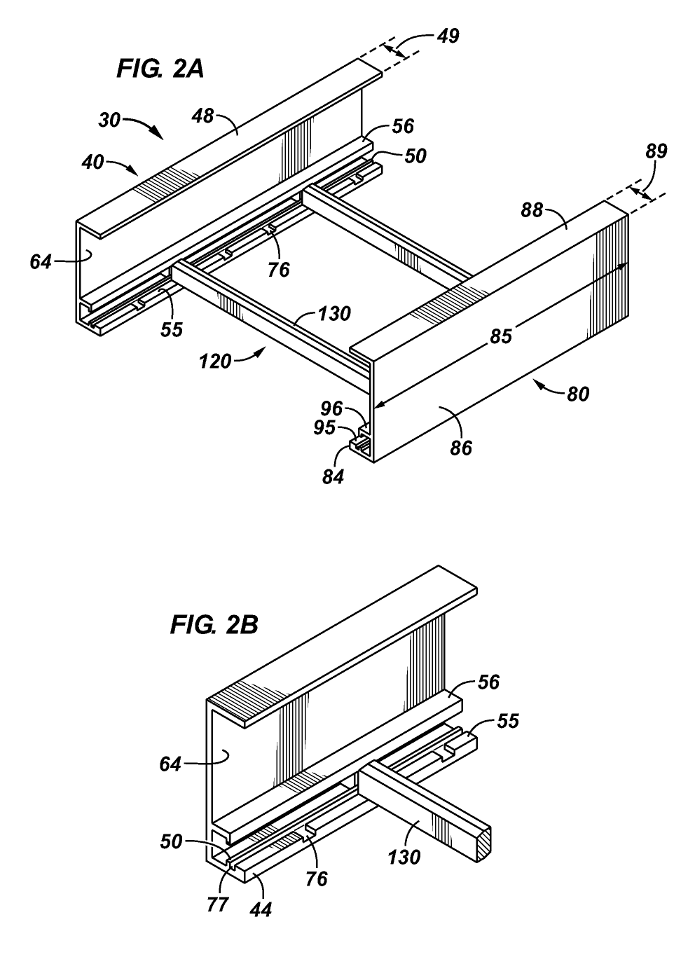

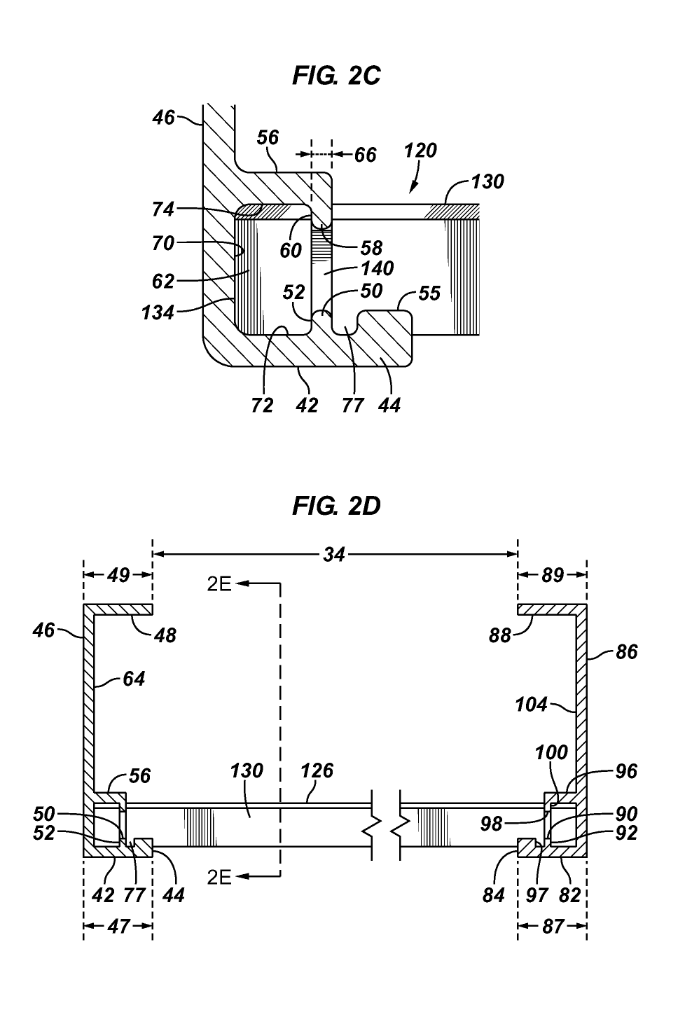

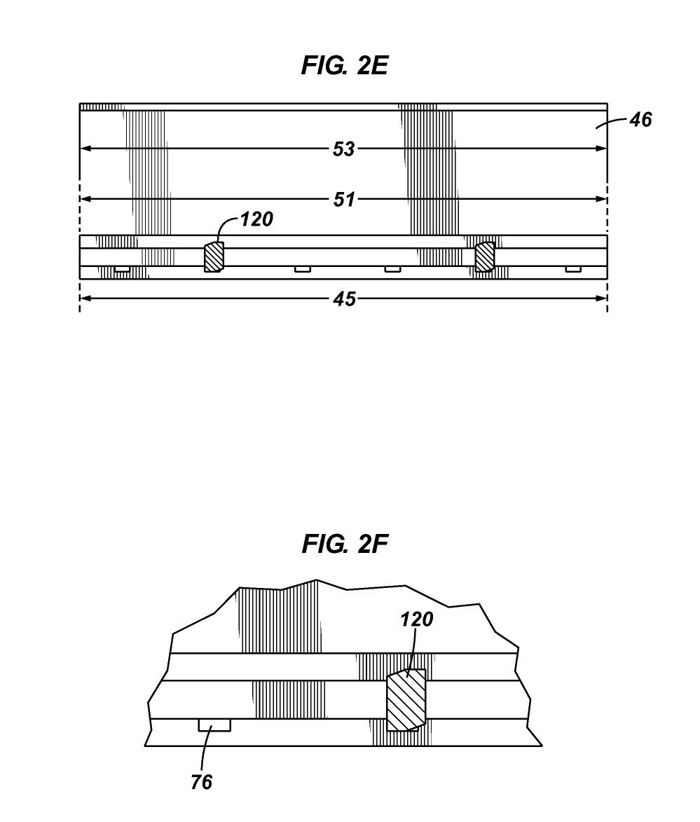

The F-beams 40, 80 each include an elongated web member 46, 86 (FIGS. 2A and 2C) defining an E-beam body. An uppermost leg member 48, 88 is connected to, extends substantially perpendicular to, and extends inwardly from an upper end portion of each E-beam body 46, 86 toward the opposite facing E-beam body. The lowermost leg members 44, 84 are connected to, extend substantially perpendicular to, and extend inwardly from a lower end portion of each E-beam body 46, 86 towards the opposite facing E-beam body. The lowermost leg members 44, 84 have substantially the same width 47, 87 as the uppermost leg members 48, 88 and extend in a substantially similar direction as and substantially parallel to the uppermost leg members 48, 88.

Each lowermost leg member 44, 84 has an upward extending lip 50, 90 extending upward from a medial portion of the lowermost leg member 44, 84. The upward extending lip 50, 90 has an outward facing surface 52, 92. The outward facing surfaces 52, 92 extend substantially the length 45, 85 of each of the lowermost leg members 44, 84. The lowermost leg members further including a portion extending inward of the upward extending lips 50, 90 to thereby define a lower ledge 55, 95.

Each of the E-beams 40, 80 of the conduit tray have a middle leg member 56, 96 connected to, extending substantially perpendicular to, and extending inwardly from a medial portion of the E-beam bodies 46, 86 in a location between the uppermost 48, 88 and lowermost leg members 44, 84 in a plane closer to the plane of the lowermost leg members 44, 84 than the plane of the uppermost leg members 48, 88. The middle leg members 56, 96 have a width less than the width 49, 89 of the uppermost 48, 88 and lowermost 44, 84 leg members and extending in a substantially similar direction as and substantially parallel to each of the uppermost 48, 88 and lowermost 44, 84 leg members. In some embodiments, the distance between the middlemost leg members 56, 96 and lowest leg members 44, 84 is less than 1.25 inches and in other embodiments, equal to 1.0 inches.

A downward extending lip 58, 98 extends downward from a distal end portion of each of the middle leg member 56, 96 toward each of the lowermost leg members 44, 84. The downward extending lips 58, 98 have an outward facing surface 60, 100 and extending substantially the length 51, 91 of the middle leg members 56, 96. An interstitial space is located between outward surfaces 52, 92 of the upward extending lip 50, 90 and the outward surfaces 60, 100 of the downward extending tip 58, 98, portions of the middle leg members 56, 96, portions of the lowermost leg member 44, 84, and inward facing portions of the E-beam body 46, 86 extending therebetween. The interstitial spaces have a substantially C-shape and extend substantially the length 53, 93 of the E-beam 40, 80 to thereby define a C-channel 62, 102.

In an embodiment of the conduit tray, a plurality of cam rungs 120, each have respective opposite end portions 122, 124 connectively positioned in a C-channel 62, 102 of the first and second E-beams 40, 80. The cam rungs 120 extend between each of the E-beams 40, 80 and are spaced apart from each other. An inward facing surface 64, 104 of each of the first E-beam 40 and second E-beam 80 and an upward facing portion 126 of each cam rung 120 form a substantially U shape conduit cavity 128. In operation, conduit 32 is positioned in the conduit cavity 128 and is contained therein.

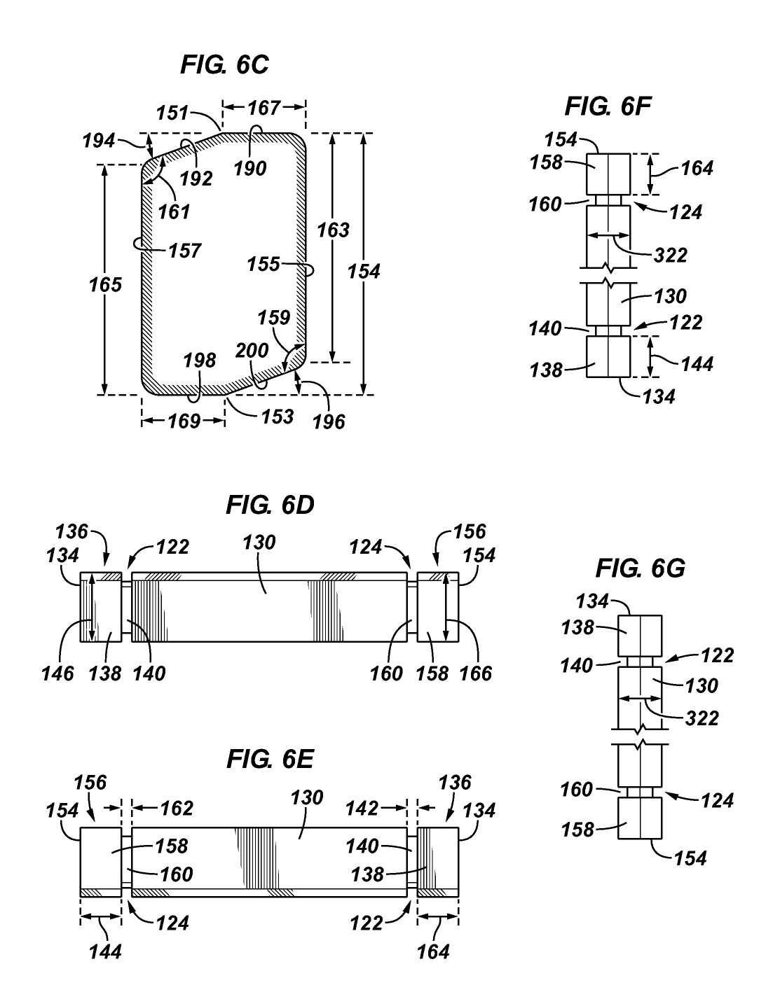

As can best be seen in FIG. 6, each cam rung 120 of this embodiment has an elongated rung body member 130. Each cam rung 120 has a first end portion 122, which includes an end 134. A first head member 136 extends inwardly from the first end 134 toward the rung body member 130 to define a first cam section 138. The outward boundary of the first cam section 138 is a first circumferential groove 140. The first circumferential groove 140 is formed in the rung body member 130 and is spaced apart from, but proximal to the first end 134. The first groove 140 also has a width 142 substantially similar to the width 66 of the downward extending lip 58 of the C-channel 62 of the first E-beam. 40 and being positioned to contactingly engage the upper extending 50 and downward extending 58 tips of the C-channel 62 of the first E-beam 40. In some embodiments the first circumferential groove 140 of each of the cam rungs extends continuously on all sides of each of the rung body members 130. In other embodiments, the first circumferential groove 140 of each of the cam rungs does not extend continuously on all sides of each of the rung body members 130, but instead only extends far enough around the rung body member 130 to engage the upper extending 50 and downward extending 58 lips of the C-channel 62 of the first E-beam 40.

Each cam rung 120 has a second end portion 124 including a second end 154 positioned substantially opposite to the first end 134 and extending inwardly from the second end 154 toward the rung body member 130. A second head member 156 extends inwardly from the second end 154 toward the rung body member 130 to define a second cam section 158. The second end 154 defines an outward boundary of the second cam section 158, and a second circumferential groove 160 formed in the rung body member, spaced apart from but proximal to the second end 154 defines an inward boundary of the second cam section 158. The second groove 160 has a width 162 substantially similar to the width 108 of the downward extending lip 98 of the C-channel 102 of the second E-beam 80. The second cam section 158 is positioned to contactingly engage the upper-extending and downward-extending lips 90, 98 of the C-channel 102 of the second E-beam 80. In some embodiments on the conduit tray, the second circumferential groove 160 of each of the cam rungs extends continuously on all sides of each of the rung body members 130. In other embodiments, the second circumferential groove 160 of each of the cam rungs does not extend continuously on all sides of each of the rung body members 130, but instead only extends far enough around the rung body member 130 to engage the upper extending 90 and downward extending 98 lips of the C-channel 102 of the second E-beam 80.

Each of the first and second cam sections 138, 158 have a width 144, 164 substantially similar to the distance between the outward facing surfaces 52, 92, 60, 100 of the lips and the inward facing portions 70, 110 of the E-beam bodies 40, 80. Each of the first and second cam sections 138, 158 have a height 146, 166 substantially similar to the distance between an upper surface 72, 112 of the lower lowermost legs 44, 84 and a lower surface 74, 114 of the middle leg members 56, 96 of the E-beam bodies 40, 80 so that each of the first and second cam sections 138, 158 matingly connect to and are retained within a respective C-channel 62, 102 of the first and second E-beams 40, 80 to connectively support the cam rung 120 thereto and within the conduit tray brace 30.

As shown in FIGS. 1 through 5 and 9 through 11, in other embodiments, the first and second E-beams 40, 80 further include a plurality of slots 76, 116 formed in and extending downwardly from upper surfaces of the lower ledge 55, 95 of the lowermost leg 44, 84 of each of the E-beams 40, 80. Each of the plurality of slots 76, 116 being spaced apart from another slot at preselected distances along the length of the lowermost leg 44, 84. Gaps 77, 117 are formed in and extend downwardly from upper surfaces of the lower ledge 55, 95 of the lowermost leg 44, 84 of each of the E-beams 40, 80. Gaps 77, 117 extend substantially the length 45, 85 of the lowermost leg members 44, 84. Gaps 77, 117 have a width 59, 99 equal to the distance between an inward facing surface, 54, 94 and an outward fixing surface, 57, 97 of the lower ledges 55, 95. In some embodiments, the widths 59, 99 are greater than zero and, in other embodiments, the widths 59, 99 may be zero.

A first portion 148 of the rung body member 130 proximal to the first cam section 138 of one of a plurality of rungs body members 130 being positioned in one of the plurality of the slots 76 of the first E-beam 40. A second portion 168 proximal to the second cam section 158 of one of a plurality of rungs 130 being positioned in one of the plurality of the slots 116 of the second E-beam 80 and being positionally aligned with the slot 76 of the first E-beam 40 to thereby stabilize the rung body member 130 within the conduit tray brace 34.

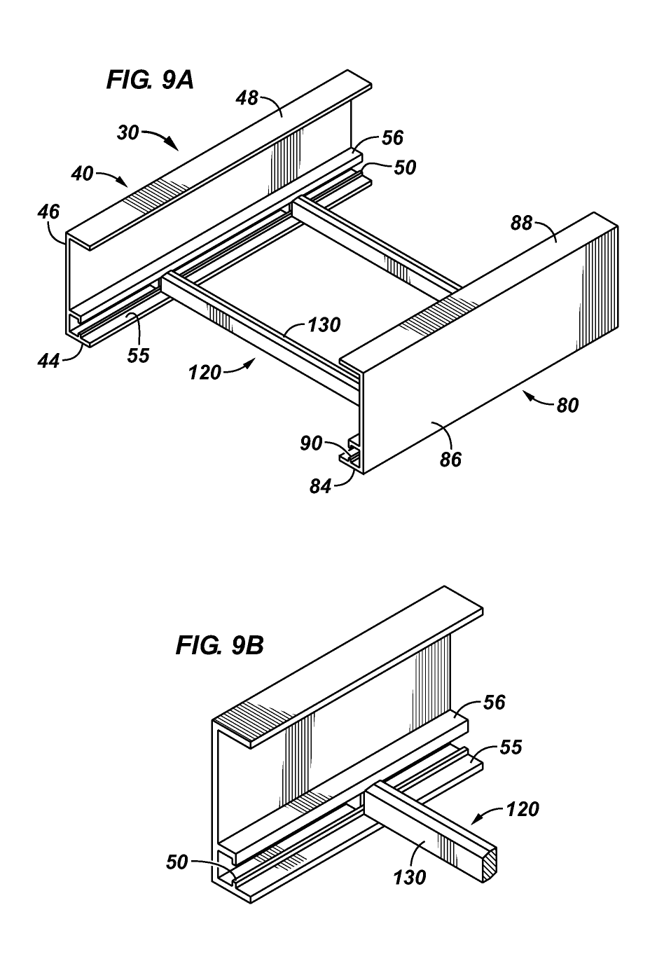

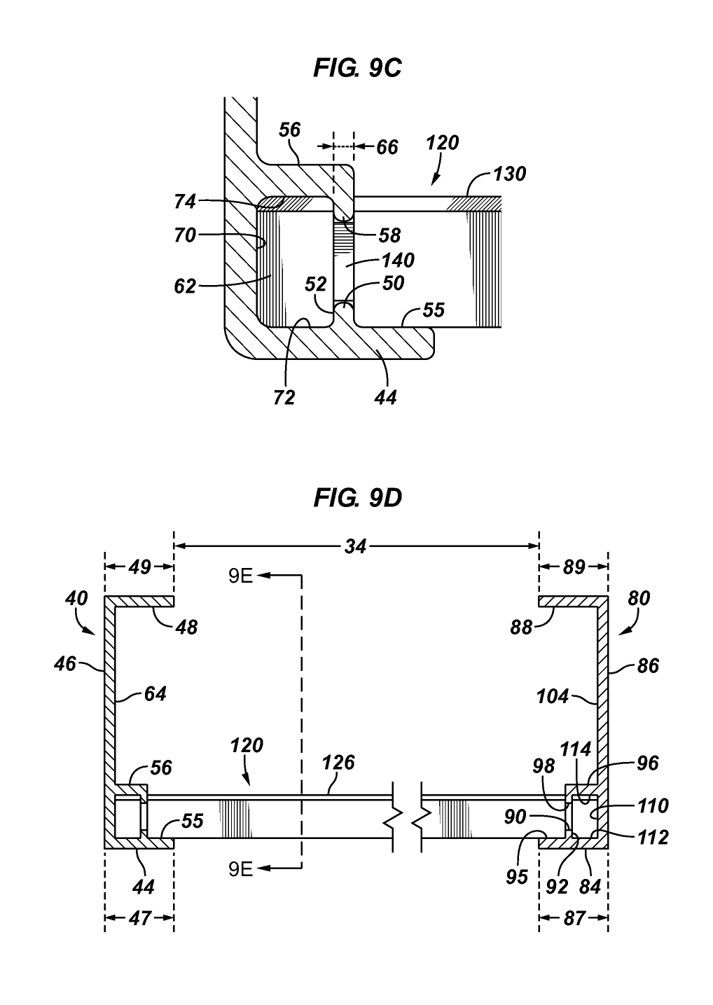

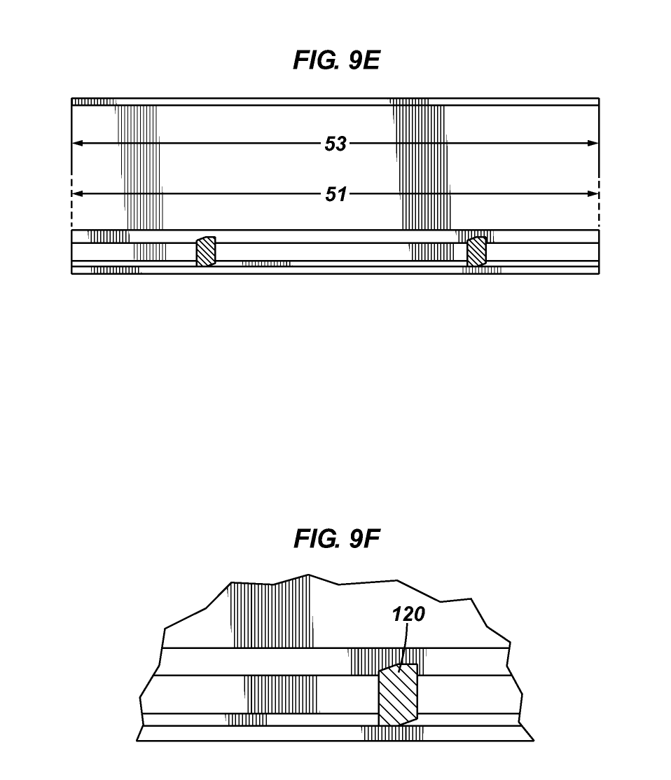

In other embodiments, there are no slots 76, 116, such as shown in FIG. 9. The use of slots would increase the stability of the rungs 130 in the E-beams 40, 80. However it may not always be possible to predict where to locate the slots and in such a case, it would be desirable to support the rung at any position along the length of E-beams 40, 80. As shown in FIG. 8, a corner is one such place. Although E-beams 40, 80 with slots 76, 116 may be beneficial for the long run straight portions 202 of the conduit tray, when using short segments to round a corner 204, it may instead be beneficial to use E-beams without slots. In such a case, a fastener, such a screw, may be used, if desired to further support the rung 130 in the E-Beams 40, 80.

In other embodiments, the cam sections 138, 158 of each of the plurality of cam body members 130 include a top end 131, 151 a bottom end 133, 153, a first side surface 135, 155 and a second side surface 137, 157, as best seen in FIG. 6B. The first side surfaces 135, 155 are opposite and substantially parallel to the second side surfaces 137, 157. The bottom ends 133, 153 comprise a plurality of surfaces extending along different planes and adjoining the first side surfaces 135, 155 at an interior angle 139, 159 greater than 90 degrees. The top ends 131, 151 also comprise a plurality of surfaces on different planes and adjoin the second side surfaces 137, 157 at an interior angle 141, 161 greater than 90 degrees.

In some embodiments, the height 143, 163 of the first side surfaces 135, 155 of each cam section 138, 158 is substantially similar in height to a height 145, 165 of the second side surfaces of that cam. A length 147, 167 of a portion of the top end 131, 151 being positioned perpendicular to the first side surfaces 135, 155 and the second side surfaces 137, 157 are substantially similar to a length 149, 169 of a portion of the bottom end 133, 153 positioned perpendicular to the first side surfaces 135, 155 and second side surfaces 137, 157. The first and second cam sections 138, 158 of each of the plurality of cam rungs 130 fill the interstitial space within the C-channels 62, 102 of the first and second E-beams 40, 80, and portions of the top ends 131, 151, bottom ends 133, 153, first side surfaces 135, 155 and second side surfaces 137, 157 of each cam section 138, 158 contacts surfaces within the C-channel 62, 102.

In some embodiments, the top surfaces 131, 151 of the cam sections 138, 158 include two separate surfaces. Each top surface 131, 151 includes a first top surface 170, 190 extending from the first side surface 135, 155 and being substantially perpendicular to the first side surface 135, 155 and the second side surface 137, 157 and a second top surface 172, 192 extending from the first top surface 170, 190 to the second side surface 137, 157. The second top surface 172, 192 is on a plane that is angled downward at a top angle 174, 194 from the plane of the first top surface 170, 190. In some embodiments, the top angle 174, 194 may be in the range of 20.5 is 21.5 degrees. In other embodiments, the top angle 174, 194 may be 20.95 degrees.

In some embodiments, the bottom surfaces 133, 153 of the cam sections 138, 158 include two separate surfaces. Each bottom surface 133, 153 includes a first bottom surface 178, 198 extending from the second side surface 137, 157 and being substantially perpendicular to the first side surface 135, 155 and the second side surface 137, 157 and a second bottom surface 180, 200 extending from the first bottom surface 178, 198 to the first side surface 135, 155. The second bottom surface 180, 200 is on a plane that is angled downward at a bottom angle 176, 196 from the plane of the first bottom surface 178, 198. In some embodiments, the bottom angle 176, 196 may be in the range of 20.5 is 21.5 degrees. In other embodiments, the bottom angle 176, 196 may be 20.95 degrees.

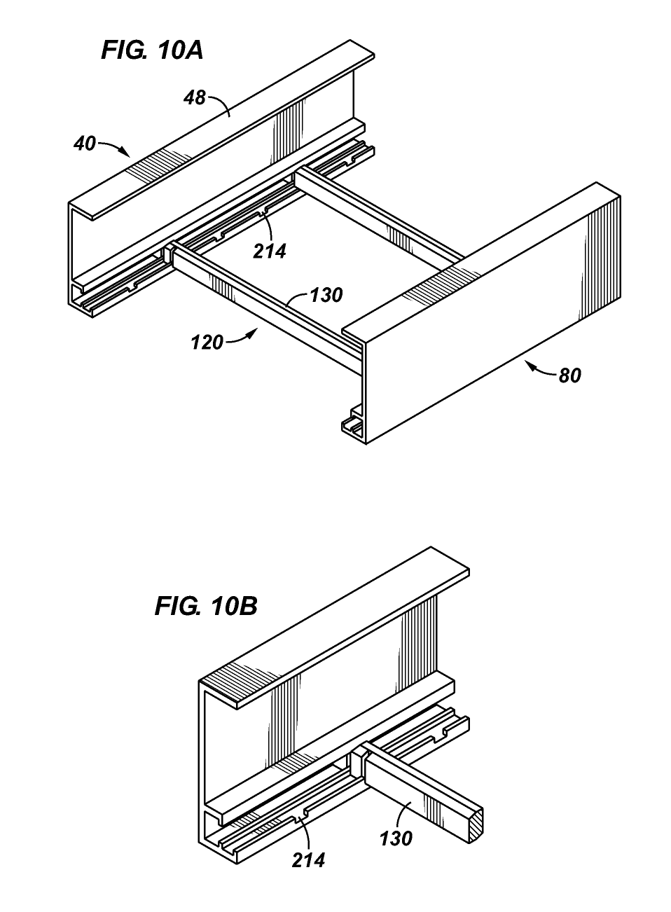

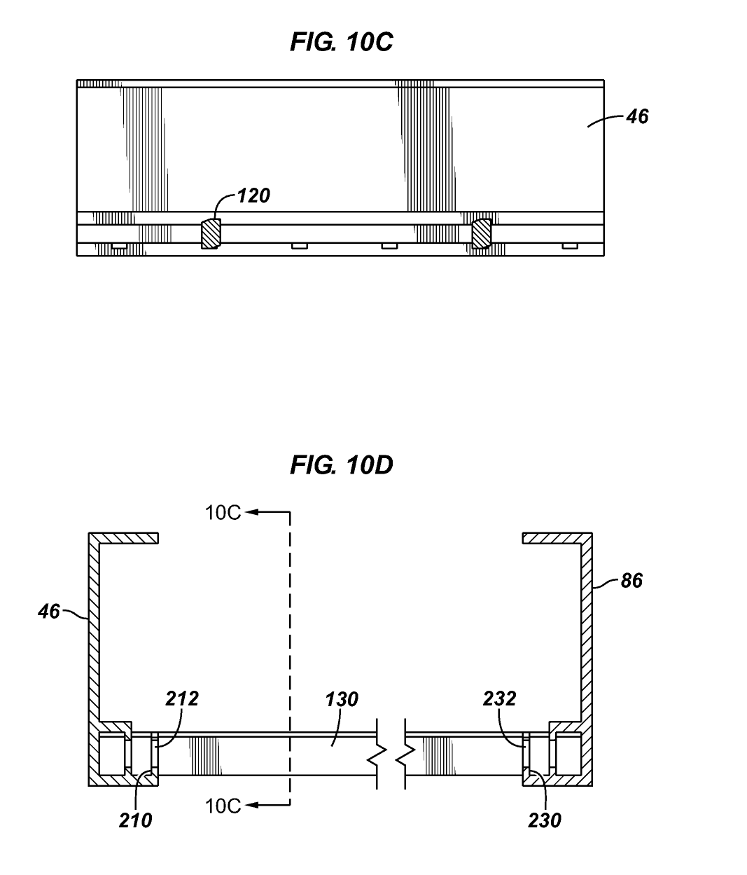

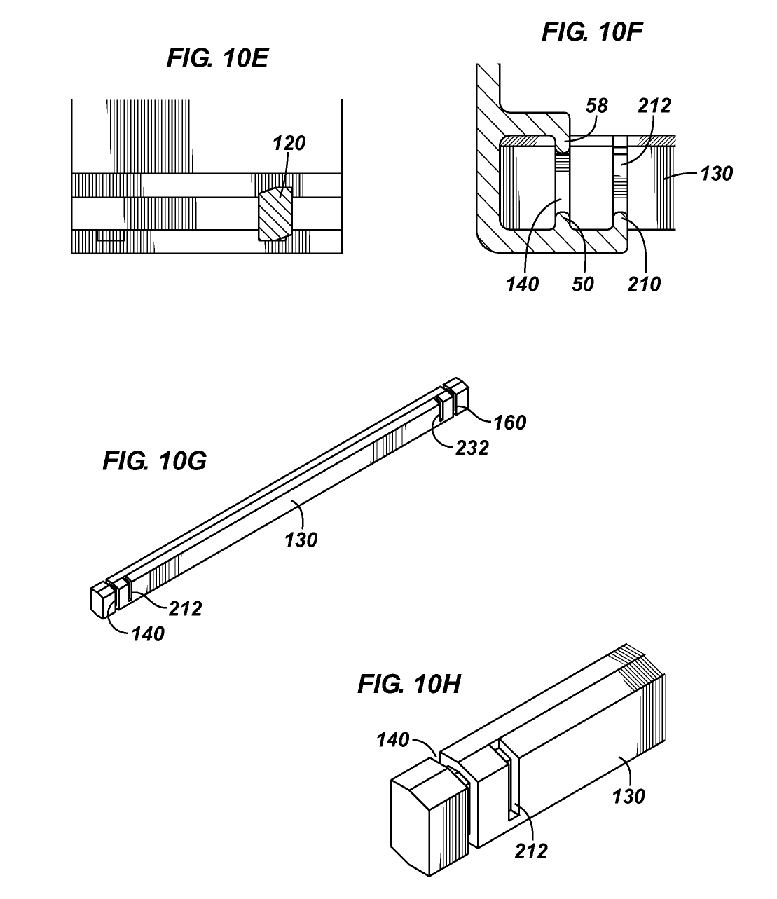

In other embodiments, such as those shown in FIG. 10, each of the first and second E-beams 40, 80 includes a secondary upward extending lip 210, 230 extending upward from a distal end portion of the lowest leg member 44, 84 toward the middle leg member 56, 96 and extending substantially the length 45, 85 of the lowest leg member 44, 84. In such embodiments, each of the plurality of cam rungs 120 further includes a first auxiliary circumferential groove 212 formed in the rung body member 130 and located proximal to the first end 134 and inward along the rung body member 130 from the first circumferential groove 140 to contactingly engage the secondary lip 210 of the first E-beam 40 to further support the first end portion 122 of the rung body member 130 to the E-beam 40. A second auxiliary circumferential groove 232 is formed in the rung body member 130 and located proximal to the second end 154 and inward along the rung body from the second circumferential groove 158 to contactingly engage the secondary lip 230 of the second E-beam 80 to further support the second end portion 124 of the rung body member 130 to the E-beam 80. The engagement of the auxiliary grooves 212, 232 with the secondary lips 210, 230 will provide additional support between the E-beams 40, 80 and the rung body members 130. Slots 214, 234 may be formed in secondary lips 210, 230, and extending downwardly from upper surfaces of the secondary tips 210, 230 and each spaced apart from another slot at preselected distances along the length 45 of the lowermost leg 44. Slots 214, 234 may have a length that is less than the length of rung body member 130 so that auxiliary grooves 212, 232 engage secondary lips 210, 230 at the same time as a lower surface of the rung body member 130 is supported by the slot 214.

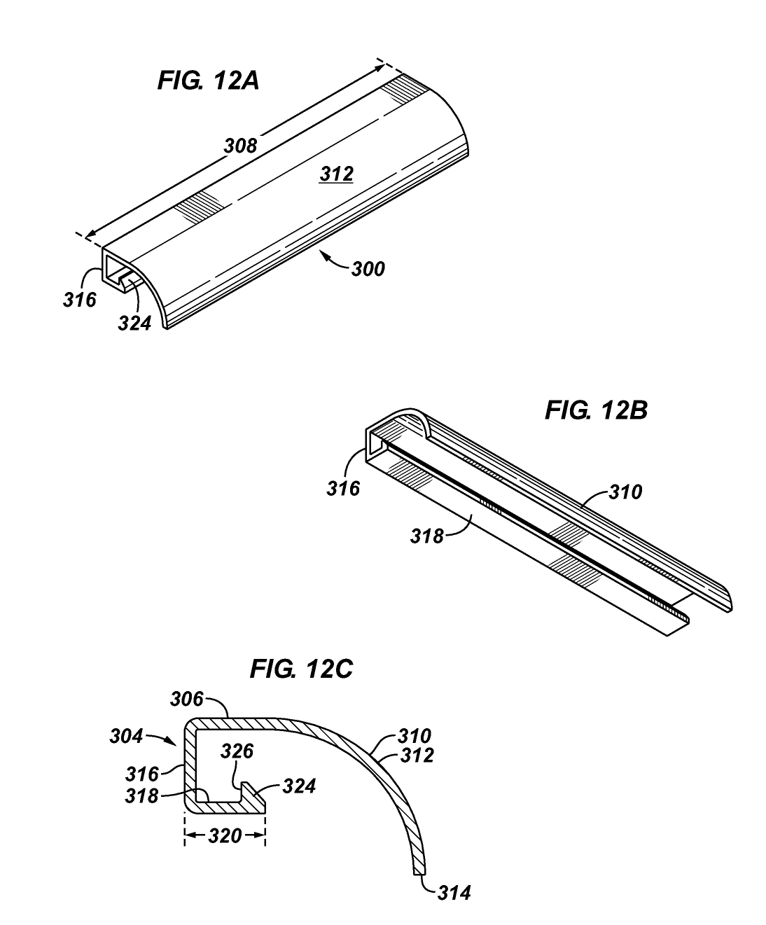

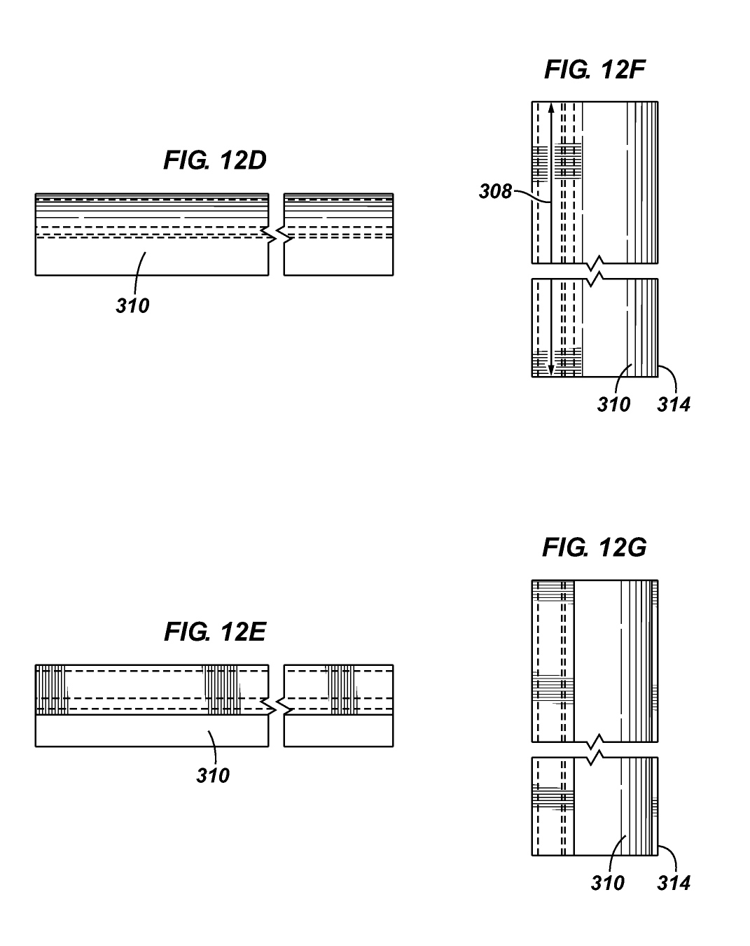

In some embodiments, a drop out may be desired. As can be seen in FIGS. 12 and 13, a drop out may comprise a curvilinear shaped plate member 302 defining a drop out 300. The shaped plate member 302 includes a central flat portion 306 with a width 308 substantially similar to the distance between the first circumferential groove 140 and the second circumferential groove 160 of a rung body member 130. Alternative, the width 308 may be smaller than the distance between the first circumferential groove 140 and the second circumferential groove 160 of a rung body member 130. In some embodiments, the central flat portion 306 has a plurality of holes 307 spaced along its width 308 and in other embodiments there are no holes through central flat portion 306.

At a first end of the shaped plate member 302, there is a first end portion 310 with a surface 312 extending in a downward arc in a direction from the central flat portion 306. The width of the first end portion 310 may be substantially similar to the width 308 of the central flat portion. The curvature of first end portion 310 is such that distal end 314 of the first end portion 310 is in a plane substantially perpendicular to the plane of the central flat portion 306.

At an end of the shaped plate member 302 opposite the first end portion 310, there is a rung engaging portion 304 of shaped plate member 302. The rung engaging portion 304 may have a width substantially similar to the width 308 of the central flat portion 306. The rung engaging portion 304 has an orthogonal plate section 316 extending from, and perpendicular to, the central flat portion 306. The height of the orthogonal plate section 316 is substantially similar to the height of a rung body member 130. Extending from the orthogonal plate section 316 and towards the first end portion 310 is a lower flat plate portion 318, which extends substantially perpendicular to the orthogonal plate section 316 and parallel to the central flat portion 306. The length 320 of lower flat plate portion 318 is longer than the length 322 of a rung body member 130.

At the proximal end of the lower flat plate portion 318 is a generally triangular shaped clamp end portion 324 extending from the lower flat plate portion 318 towards the central flat portion 306. Clamp end portion 324 has a surface 326 which is substantially parallel to the orthogonal plate section 316 to form a rung grip. Surface 326 of clamp end portion 324 abuttingly contacts a side of a rung body member 130. The distance between a surface 326 and the interior surface of the orthogonal plate section 316 is substantially similar to the length 322 a rung body member so that the and the rung engaging portion 304 of the drop out 300 engages a rung body member 130 to position the drop out 300 to the rung body member 130.

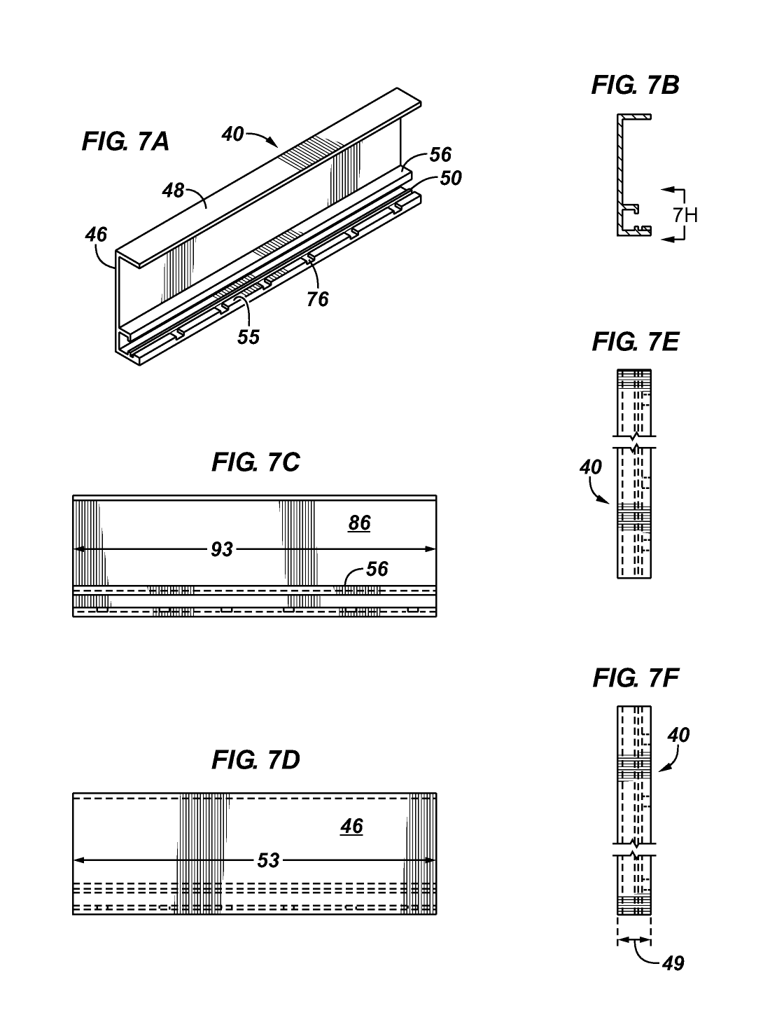

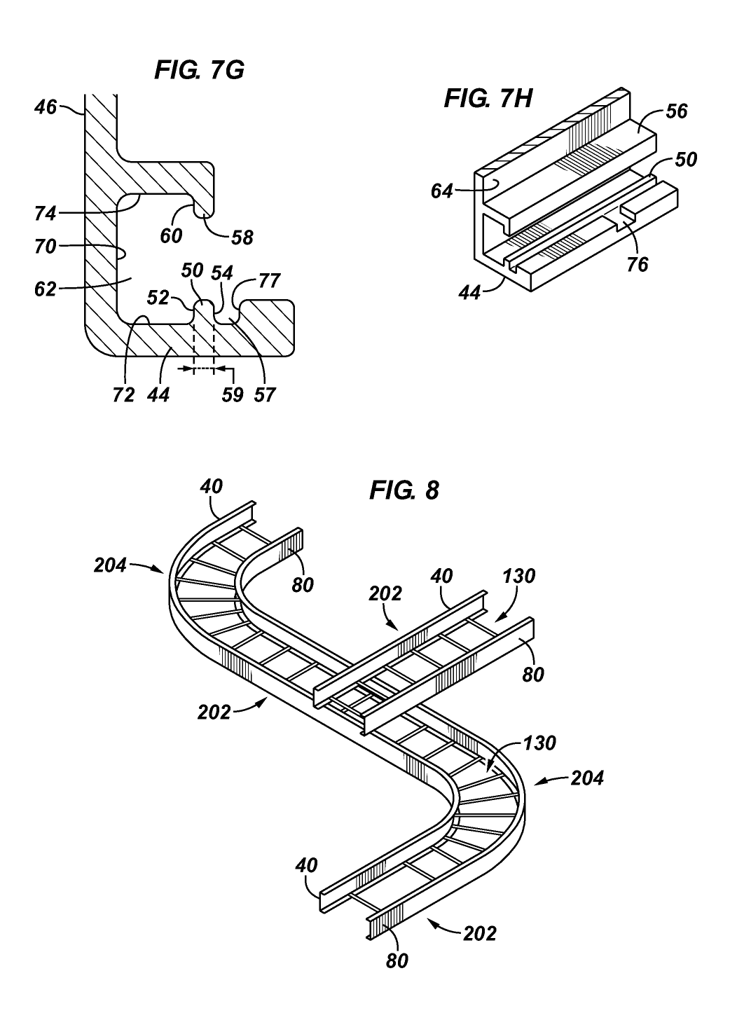

As can best be seen in FIG. 7, in one embodiment of a brace member 40, an elongated web member defines a beam body 46. A lowermost leg member 44 is connected to and extending substantially perpendicular to a lower end portion of the beam body 46, and extends substantially the length 53 of the beam body 46. An upward extending lip 50 extending upward from a medial portion of the lowermost leg member 44, extending substantially the length 45 of the lowermost leg member 44.

A middle leg member 56 is connected to and extending substantially perpendicular to, a medial portion of the beam body 46 in a location above the lowermost leg member 44, extending substantially the length 45 of the beam body 46. The middle leg member has a width less than a width 47 of the lowermost leg members 44 and extends in a direction substantially similar to the lowermost leg members 44, so that the extent of the middle leg member 56 is substantially parallel to the lowermost leg member 44. In some embodiments, there is no uppermost leg member 48.

A downward extending lip 58 extends downward from a distal end portion of the middle leg member 56 toward the lowermost leg member 44. The downward extending tip 58 extends substantially the length 51 of the middle leg members 56. An interstitial space is located between surfaces of the upward extending tip 50 and the downward extending lip 58, portions of the middle leg members 56, portions of the lowermost leg member 44, and portions of the beam body 46 extending therebetween. The interstitial space has a substantially C-shape and extends substantially the length 53 of the E-beam 40 to thereby define a C-channel 62.

Although FIG. 7 shows an uppermost leg member, in some embodiments, there is no uppermost leg member and the shape of the brace member 40 resembles an inverted F rather than an E.

In some embodiments, the lowermost leg member 44 has a portion extending beyond the upward extending lip 50 to thereby define a lower ledge 55. The lower ledge may have a plurality of slots 76 formed in and extending downwardly from upper surfaces of the lower ledge 55 and each spaced apart from another slot at preselected distances along the length 45 of the lowermost leg 44. In other embodiments, there are no slots 76 in lower ledge 55. In other embodiments, there may be no lower ledge 55. Both the slots 76 and the lower ledge 55 provide additional support to any member connecting with the brace member, however in some design situations, the additional support may not be needed, which is not to suggest that other features are required in every embodiment.

In other embodiments, the lowermost leg member 44 has a secondary upward extending lip 210 extending upward from a distal end portion of the lowermost leg member 44 toward the middle leg member 56, extending substantially the length 45 of the lowermost leg member 44.

An embodiment of a cam member, shown as a rung body member 300 in FIG. 6, has a circumferential groove 140 formed in the cam body member 300 and located proximal to the end 134 to engage a portion of a brace. The end portion 134 will be matingly positioned within a portion of the brace. The cam section 138 is defined at its outward end by the end 134 and at its inner end by the circumferential groove 140. The cam section includes a top end 131, a bottom end 133, a first side surface 135 and a second side surface 137. The first side 135 surface is opposite and substantially parallel to the second side surface 137. The bottom end 133 comprises a plurality of surfaces on different planes and meeting the first side surface 135 at an interior angle 139 greater than 90 degrees. The top end 131 comprises a plurality of surfaces on different planes and meets the second side surface 137 at an interior angle 139 greater than 90 degrees.

In some embodiments, the height 143 first side surface 135 is substantially similar in height to a height 145 of the second side surface 137. A length 147 of a portion of the top end 131 which is perpendicular to the first side surface 135 and second side surface 137 is substantially similar to a length 149 of a portion of the bottom end 133 which is perpendicular to the first side surface 135 and second side surface 137.

In some embodiments, the top surface 131 of the cam section 138 includes two separate surfaces. The top surface 131 includes a first top surface 170 extending from the first side surface 135 and being substantially perpendicular to the first side surface 135 and the second side surface 137 and a second top surface 172 extending from the first top surface 170 to the second side surface 137. The second top surface 172 is on a plane that is angled downward at a top angle 174 from the plane of the first top surface 170. In some embodiments, the top angle 174 may be in the range of 20.5 is 21.5 degrees. In other embodiments, the top angle 174, 194 may be 20.95 degrees.

In some embodiments, the bottom surface 133 of the cam sections 138 includes two separate surfaces. The bottom surface 133 includes a first bottom surface 178 extending from the second side surface 137 and being substantially perpendicular to the first side surface 135 and the second side surface 137, and a second bottom surface 180 extending from the first bottom surface 178 to the first side surface 135. The second bottom surface 180 is on a plane that is angled downward at a bottom angle 176 from the plane of the first bottom surface 178. In some embodiments, the bottom angle 176 may be in the range of 20.5 is 21.5 degrees. In other embodiments, the bottom angle 176 may be 20.95 degrees.

In one embodiment of the present invention, a cam connector mating connects a member therein. The cam connector comprises both a cam member and a brace member. An example of a brace member is the C-channel 62 as previously described. An example of a cam connector is the cam rung 120 as previously described. However, alternative cam member and brace members may be understood by those skilled in the art. In one embodiment, the cam connector includes a brace member 40 having a brace body 46. The brace member also has a lowermost leg member 44 connected to, extending substantially perpendicular to, and extending from a lower end portion of the brace body 46. An upward extending lip 50 extends upward from a medial portion of the lowermost leg member 44.

A middle leg member 56 is connected to, extends substantially perpendicular to, and extends from a medial portion of the brace body 46 in a location above the lowermost leg member 44, extending in a substantially similar direction as lowermost leg member 44, no that the extent of the middle leg member 56 is substantially parallel to the lowermost leg member 44. A downward extending lip 58 extends downward from a distal end portion of the middle leg 56 member toward the lowermost leg member 44, so that interstitial space is located between surfaces of the upward extending lip 50 and the downward extending lip 58, portions of the middle leg member 56, portions of the lowermost leg member 44, and portions of the brace body 46 extending therebetween. The interstitial space has a substantially C-shape to thereby define a C-channel 62.

The cam connector also includes a cam member 130 to mate with the brace member 40. The cam body member 130 has a circumferential groove 140 formed in the cam body member 300 and located proximal to the end 134 to engage a portion of a brace. The end portion 134 will be matingly positioned within a portion of the brace. The cam section 138 is defined at its outward end by the end 134 and at its inner end by the circumferential groove 140. The cam section includes a top end 131, a bottom end 133, a first side surface 135 and a second side surface 137. The first side 135 surface is opposite and substantially parallel to the second side surface 137. The bottom end 133 comprises a plurality of surfaces on different planes and meeting the first side surface 135 at an interior angle 139 greater than 90 degrees. The top end 131 comprises a plurality of surfaces on different planes and meets the second side surface 137 at an interior angle 139 greater than 90 degrees. The cam section 138 substantially fills the interstitial space within the C-channel 62 of the brace, and portions of the top end 131, bottom end 133, first side surface 135, and second side surface 137 of the cam section contacting surfaces within the C-channel.

In some embodiments of the cam connector, the height 143 first side surface 135 is substantially similar in height to a height 145 of the second side surface 137. A length 147 of a portion of the top end 131 which is perpendicular to the first side surface 135 and second side surface 137 is substantially similar to a length 149 of a portion of the bottom end 133 which is perpendicular to the first side surface 135 and second side surface 137.

In some embodiments of the cam connector, the top surface 131 of the cam section 138 include two separate surfaces. The top surface 131 includes a first top surface 170 extending from the first side surface 135 and being substantially perpendicular to the first side surface 135, the second side surface 137, and a second top surface 172 extending from the first top surface 170 to the second side surface 137. The second top surface 172 is on a plane that is angled downward at a top angle 174 from the plane of the first top surface 170. In some embodiments, the top angle 174 may be in the range of 20.5 is 21.5 degrees. In other embodiments, the top angle 174, 194 may be 20.95 degrees.

In some embodiment of the cam connector, the bottom surface 133 of the cam sections 138 includes two separate surfaces. The bottom surface 133 includes a first bottom surface 178 extending from the second side surface 137 and being substantially perpendicular to the first side surface 135 and the second side surface 137, and a second bottom surface 180 extending from the first bottom surface 178 to the first side surface 135. The second bottom surface 180 is on a plane that is angled downward at a bottom angle 176 from the plane of the first bottom surface 178. In some embodiments, the bottom angle 176 may be in the range of 20.5 is 21.5 degrees. In other embodiments, the bottom angle 176 may be 20.95 degrees.

In other embodiments of the cam connector 300, the lowermost leg member 44 has a secondary upward extending lip 210 extending upward from a distal end portion of the lowermost leg member 44 toward the middle leg member 56, extending substantially the length 45 of the lowermost leg member 44. In such embodiments, each of the cam rungs 130 further includes a first auxiliary circumferential groove 212 to contactingly engage the secondary lip 210 to further support the rung body member 130 to the brace body 46.

In some embodiments of the cam connector, the lowermost leg member 44 has a portion extending beyond the upward extending lip 50 to thereby define a lower ledge 55. The lower ledge may have a plurality of slots 76 formed in and extending downwardly from upper surfaces of the lower ledge 55 and each spaced apart from another slot at preselected distances along the length 45 of the lowermost leg 44. In other embodiments, such as show in FIG. 9, there are no slots.

Other embodiments of the current invention include a brace and rung structure. This structure includes a first brace member 40 and a second brace member 80, the second brace member 80 being positioned spaced apart and facing an opposite direction of the first brace member 40. Each of the brace members 40, 80 has a web member defining a brace body 46, 86. Each brace member also has a lowermost leg member 44, 84 connected to, extending substantially perpendicular to, and extending inwardly from a lower end portion of the brace body 46, 86.

In this embodiment of a brace and rung structure, an upward extending tip 50, 90 extends upward from the lowermost leg members 44, 84. A middle leg member 56, 96 is connected to, extending substantially perpendicular to, and extending inwardly from a medial portion of each brace body 46, 86 in a location above the lowermost leg member 44, 84. A downward extending lip 58, 98 extends downward from a distal end portion of each of the middle leg members 56, 96 towards the lowermost leg members 45, 85, so that interstitial space is located between surfaces of the upward extending lip 50, 90 and the downward extending lip 58, 98, portions of the middle leg member 56, 96, portions of the lowermost leg member 44, 84, and portions of the brace body 46, 86 extending therebetween have a substantially C-shape to thereby define a. C-channel 62, 102 for each brace body 46, 86.

The embodiment of the brace and rung structure also includes at least one cam rung 120 connected to and extending between each of the brace members 40. Each cam rung has an elongated rung body member 130. Each cam rung 120 also has a first end portion 122, which includes an end 134. A head member 136 extends inwardly from the first end 134 toward the rung body member 130 to define a first cam section 138. The outward boundary of the first cam section 138 is a first circumferential groove 140. The first circumferential groove 140 is formed in the rung body member 130, and is spaced apart from but proximal to the first end 134. The first groove being positioned to contactingly engage the upper extending 50 and downward extending 58 lips of the C-channel 62 of the first brace member 40.

Each cam rung 120 has a second end portion 124 including a second end 154 positioned substantially opposite to the first end 134 and extending inwardly from the second end 154 toward the rung body member 130. The second end 124 defines an outward boundary of the second cam section 158, and a second circumferential groove 160 formed in the rung body member, spaced apart from but proximal to the second end 154 defines an inward boundary of the second cam section 158. The second cam section 158 is positioned to contacting engage the upper extending 90 and downward extending 98 lips of the C-channel 102 of the second E-beam 80.

The cam section of the brace and rung structure includes a top end 131, a bottom end 133, a first side surface 135 and a second side surface 137. The first side 135 surface is opposite and substantially parallel to the second side surface 137. The bottom end 133 comprises a plurality of surfaces on different planes and meeting the first side surface 135 at an interior angle 139 greater than 90 degrees. The top end 131 comprises a plurality of surfaces on different planes and meets the second side surface 137 at an interior angle 139 greater than 90 degrees. The cam section 138 substantially fills the interstitial space within the C-channel 62 of the brace, and portions of the top end 131, bottom end 133, first side surface 135, and second side surface 137 of the cam section contacting surfaces within the C-channel.

In some embodiments of the cam connector for the brace and rung structure, the height 143 first side surface 135 is substantially similar in height to a height 145 of the second side surface 137. A length 147 of a portion of the top end 131 which is perpendicular to the first side surface 135 and second side surface 137 is substantially similar to a length 149 of a portion of the bottom end 133 which is perpendicular to the first side surface 135 and second side surface 137.

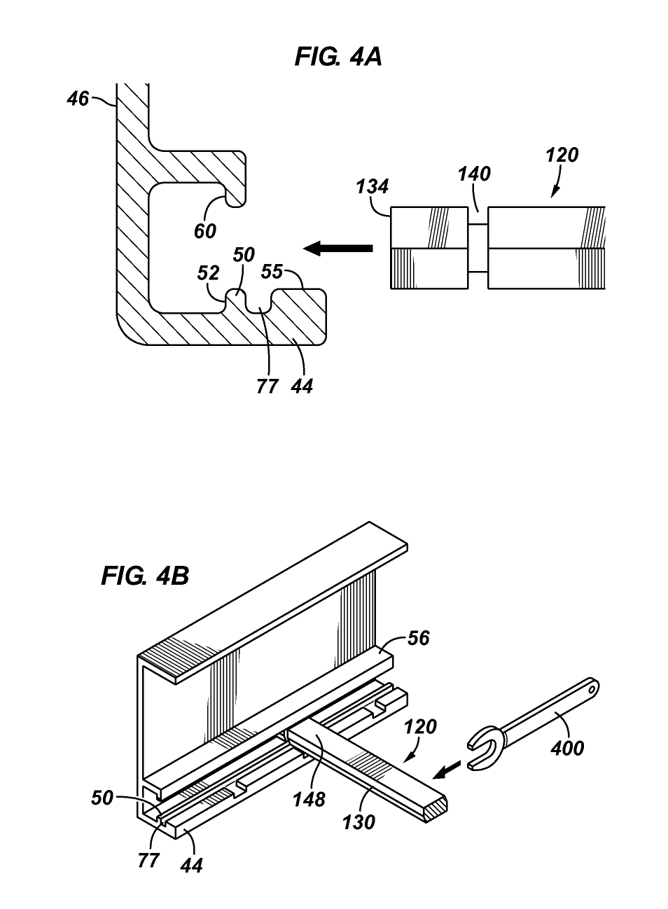

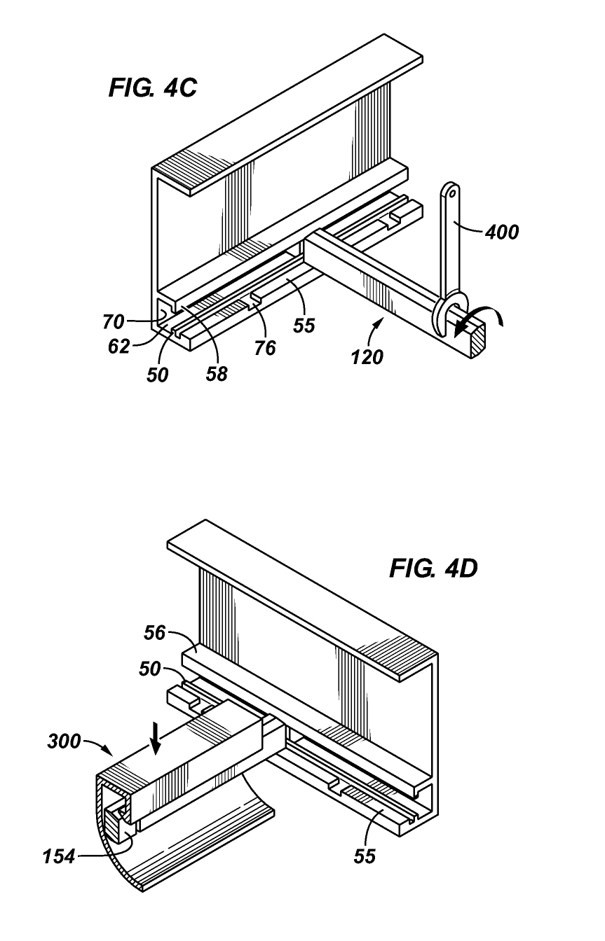

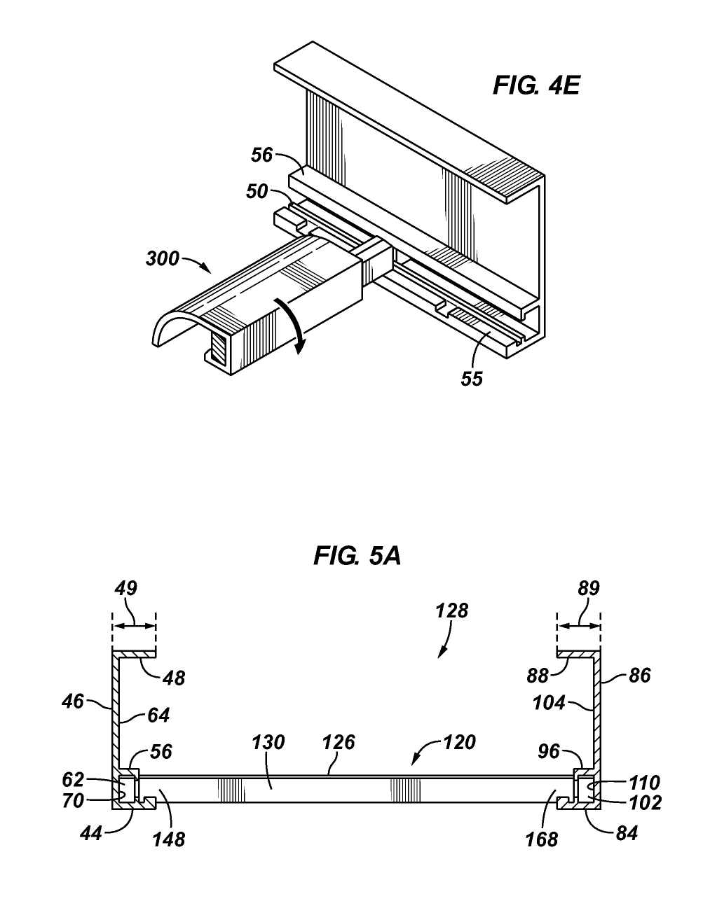

Another embodiment of the current invention is a method of assembling a rung interface, as best illustrated in FIG. 4. The method of this embodiment includes providing a brace member 40. The brace member has a web portion defining a brace body 46 and a lowermost leg member 44 connected to, extending substantially perpendicular to, and extending inwardly from a lower end portion of the brace body 46, extending substantially the length of the brace body 46. The brace member 40 also includes an upward extending lip 50 extending upward from a medial portion of the lowermost leg member 44, and extending substantially the length of the lowermost leg member 44. A middle leg member 56 is connected to, extending substantially perpendicular to the brace body in a location above the lowermost leg member 44. The middle leg member 56 extends substantially the length of the brace body 46. The middle leg member 56 has a width less than the width 45 of the lowermost leg member 44 and extends in a substantially similar direction as the lowermost leg member 44, so that the extent of the middle leg member 56 is substantially parallel to the extent of the lowermost leg member 44. A downward extending lip 58 extends downward from a distal end portion of the middle leg member 56 toward the lowermost leg member 44 and extends substantially the length of the middle leg member. Interstitial space is located between surfaces of the upward extending lip 50 and the downward extending lip 58, portions of the middle leg member 56, portions of the lowermost leg member 44, and an inward facing portions of the brace body 46 extending therebetween. The interstitial space has a substantially C-shape and extends substantially the length of the brace member 40 to thereby define a C-channel 62.

The next step in the method of an embodiment of the current invention is to position an end portion of a rung body member 130 between the downward extending lip 58 and the upward extending lip 90 within the C-channel 62, such that an end surface of the rung body 130 abuttingly contacts an inward facing portion of the brace body 46 and the end portion of the body member 40 is located within the C-channel 62 in an unsupported position.

Then the rung body member 40 is rotated such that a circumferential groove 140 formed in the rung body member 130 and located proximal to a rung end 134 of the rung body member 130 matingly engages the downward extending lip 58 and upward extending lip 50 of the brace member 40. The end portion 134 of the rung body 130 proximal to the rung end extending outwardly from the circumferential groove 140 defines a cam section 138 of the rung body 130, such that the cam section 138 of the rung body member is 130 in a supported position within the C-channel.

As is apparent from this description, in some embodiments, mating engaging the rung body member 40 and the lips 58 and 50 may entail forming an interference fit (e.g., a friction fit) between these parts, such that the respective parts press against each other, causing each other to deviate slightly from their nominal dimensions, and thereby enhancing friction at their mating surfaces, such that the parts tend to stay locked into position. Consequently, when assembled, the rung body memory 40 may experience an internal compressive strain from top to bottom, e.g., in the direction of dimension 1154 of FIG. 6C, and the C-channel may experience a net tensile strain, from having the top and bottom lips 58 and 50 pressed apart by the rung body memory 40. In some cases, the member 40 resiliently distorts the shape of the C-channel as the member 40 is rotated, driving the lips 58 and 50 apart, and then when in the installed position, the lips 58 and 50 resiliently return (partially or fully) to their un-distorted position, thereby tending to hold the member 40 in place. Friction fitting and resiliently locking components in place is expected to reduce the use of more complicated assembly techniques, such as use of adhesives.

In alternative method embodiments of the present invention, a second brace member 80 is positioned spaced apart and facing an opposite direction as the first brace member 40. A second end portion 124 of the rung body member 130 is positioned between the downward extending lip 58 and the upward extending lip 50 within the C-channel of the second brace member 80. The rung body 130 is rotated such that the cam section 138 of the rung body member 130 is in a supported position and the second end portion 154 of the rung body member 130 is in a supported position within the second brace member 80.

In another alternative embodiment the rung body member 130 is rotated until the cam section 138 of the rung body member 130 substantially fills the interstitial space of the C-channel 62 and a portion of a top end 131, a portion of a bottom end 133, a portion of a first side surface 135, and a portion of a second side surface 137 of the cam sections, abuttingly contacting surfaces within the C-channel 62. The rotation of the rung body 130 may be accomplished by using a special tool 400. Alternatively, it made me rotated by hand or by machine. The rung body 130 may be rotated 90 degrees.

Yet another embodiment includes the steps of locating a rung engaging portion 304 of a drop out 300 over the rung body 130. The dropout 300 comprises a central flat portion of plate 306 and a first end portion 310 with a surface extending in a downward arc away from the central flat portion 306. The rung engaging portion 304 is at a second end of the central fiat portion 306 opposite the curved first end portion 310. Linear and rotating force is then applied to the drop out 300 to create an abutting contact between a face of a rung grip 324 of the drop out 300 and a bottom surface of the rung body member 130. The rung grip 324 being located at the distal end of the rung engaging portion 304 and having a generally triangular shape.

Embodiments of conduit trays to support conduits, braces to retain a cam body member, cam members to mate with braces, a cam connector, a brace and rung structure, and associated methods have been described and illustrated herein that allow for simple construction of support conduits. Although the example of a conduit tray has been used throughout, the invention may equally apply to other connecting structures, such as covers and lids.

Further, as will be apparent from the above description of assembly methods, embodiments include various permutations of the above-described component embodiments, such as kits containing one or more pairs of brace members, a plurality of the above described rungs, and one or more of the above-described drop-outs, or permutations thereof. In some cases, the individual components described above are independently useful, for instance for mating with existing structures like those described above as replacement parts or expansion parts. Thus, it should be understood that while the above description addresses embodiments being installed into exemplary site-specific rung structures, embodiments are no limited to such assembled structures and may include kits of individual components or individual components themselves.

Many modifications and other embodiments of the invention will come to the mind of those skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A conduit tray to support conduits, the conduit tray comprising:
a first brace member having a substantially overall E-shape to define a first E-beam;
a second brace member having a substantially overall E-shape to define a second E-beam, the second E-beam being positioned spaced apart and facing an opposite direction as the first E-beam so that lower surfaces of a lowermost leg member of each the first and second E-beams is positioned in substantially the same plane and so that collectively the first and second E-beams define a conduit tray brace, each of the first and second E-beams including:
an elongated web member defining an E-beam body,
an uppermost leg member connected to, extending substantially perpendicular to, and extending inwardly from an upper end portion of the E-beam body toward an opposite facing E-beam body,
the lowermost leg member also being connected to, extending substantially perpendicular to, and extending inwardly from a lower end portion of the E-beam body toward an opposite facing E-beam body, the lowermost leg member having substantially the same width as the uppermost leg member and extending in a substantially similar direction as and substantially parallel to the uppermost leg member,
an upward extending lip extending upward from a medial portion of the lowermost leg member, having an outward facing surface, and extending substantially the length of the lowermost leg member, the lowermost leg member further including a portion extending inward of the upward extending lip to thereby define a lower ledge,
a middle leg member connected to, extending substantially perpendicular to, and extending inwardly from a medial portion of the E-beam body in a location between the uppermost and lowermost leg members in a plane closer to the plane of the lowermost leg than the plane of the uppermost leg, the middle leg member having a width less than the width of the uppermost and lowermost leg members and extending in a substantially similar direction as and substantially parallel to each of the uppermost and lowermost leg members, and
a downward extending lip extending downward from a distal end portion of the middle leg member toward the lowermost leg member, having an outward facing surface, and extending substantially the length of the middle leg member so that interstitial space located between outward surfaces of the upward extending lip and the downward extending lip, portions of the middle leg member, portions of the lowermost leg member, and inward facing portions of the E-beam body extending therebetween have a substantially C-shape extending substantially the length of the E-beam to thereby define a C-channel;
a plurality of cam rungs each spaced apart from another cam rung, having respective opposite end portions connectively positioned in each respective C-channel of the first and second E-beams, and extending between each of the E-beams so that an inward facing surface of each of the first E-beam and second E-beam and an upward facing portion of each cam rung form a substantially U shape to thereby define a conduit cavity and so that when conduit is positioned in the conduit cavity the conduit is contained therein, each cam rung including:
an elongated rung body member;
a first end portion including a first end, a head member extending inwardly from the first end toward the rung body member to define a first cam section and so that the first end defines an outward boundary of the first cam section, and a first circumferential groove spaced apart from, proximal to the first end and the first cam section, formed in the rung body member, and defining an inward boundary of the first cam section, the first groove also having a width substantially similar to the each of the width of the downward extending lip of the C-channel of the first E-beam and being positioned to contactingly engage the upper extending and downward extending lips of the C-channel of the first E-beam, and
a second end portion including a second end positioned substantially opposite to the first end and extending inwardly from the second end toward the rung body member to define a second cam section and so that the second end defines an outward boundary of the second cam section, and a second circumferential groove spaced apart from, proximal to the second end and the second cam section, formed in the rung body member, and defining an inward boundary of the second cam section, the second groove also having a width substantially similar to the width of the downward extending lip of the C-channel of the second E-beam and being positioned to contactingly engage the upper extending and downward extending lips of the C-channel of the second E-beam, each of the first and second cam sections having a width substantially similar to the distance between the outward facing surfaces of the lips and the inward facing portions of the E-beam body and a height substantially similar to the distance between an upper surface of the lower lowermost leg and a lower surface of the middle leg member of the E-beam body so that each of the first and second cam sections matingly connect to and retain within a respective C-channel of the first and second E-beams to connectively support the cam rung thereto and within the conduit tray brace.

2. A conduit tray as defined in claim 1, wherein:
each of the first and second E-beams further includes gap formed in and extending downwardly from upper surfaces of the lower ledge of the lowermost leg of each of the E-beams, the gap extending substantially the length of each of the E-beams; and
each of the first and second E-beams further includes a plurality of slots formed in and extending downwardly from upper surfaces of the lower ledge of the lowermost leg of each of the E-beams, each of the plurality of slots being spaced apart from another slot at preselected distances along the length of the lowermost leg, a first portion of the rung body member proximal to the first cam section of one of a plurality of rungs being positioned in one of the plurality of the slots of the first E-beam, a second portion proximal to the second cam section of one of a plurality of rungs being positioned in one of the plurality of the slots of the second E-beam and being positionally aligned with the slot of the first E-beam to thereby stabilize the rung body member within the conduit tray brace, and the distance between the middlemost leg member and lowest leg member is less than 1.25 inches.

3. A conduit tray as defined in claim 1, the cam sections of each of the plurality of cam rungs includes atop end, a bottom end, a first side surface and a second side surface, the first side surface being opposite and substantially parallel to the second side surface, the bottom end comprising a plurality of surfaces extending along different planes and adjoining the first side surface at an interior angle greater than 90 degrees, the top end comprising a plurality of surfaces on different planes and adjoining the second side surface at an interior angle greater than 90 degrees.

4. A conduit tray as defined in claim 3, wherein the first side surface of each cam section is substantially similar in height to a height of the second side surface and a length of a portion of the top end being positioned perpendicular to the first side surface, the second side surface being substantially similar to a length of a portion of the bottom end positioned perpendicular to the first side surface and second side surface and the first, second cam sections of each of the plurality of cam rungs an interstitial space within the C-channels of the first and second E-beams, and portions of the top end, bottom end, first side surface and second side surface of each cam section contacts surfaces within the C-channel.

5. A conduit tray as defined in claim 4, wherein the plurality of top surfaces of each of the first and second cam sections includes a first top surface extending from the first side surface and being substantially perpendicular to the first side surface and the second side surface and a second top surface extending from the first top surface to the second side surface, the second top surface being on a plane that is angled downward from the plane of the first top surface; and the plurality of bottom surfaces of each of the first and second cam sections includes a first bottom surface extending from the second side surface and being substantially perpendicular to the first side surface and the second side surface and a second bottom surface extending from the first bottom surface to the first side surface, the second bottom surface being on a plane that is angled upward from the plane of the first bottom surface.

6. A conduit tray as defined in claim 5, wherein the angle extending between the plane of the first top surface and the plane of the second top surface is in the range of 20.5 is 21.5 degrees and the angle extending between the plane of the first bottom surface and the plane of the second bottom surface is in the range of 20.5 is 21.5 degrees.

7. A conduit tray as defined in claim 5, wherein the angle extending between the plane of the first top surface and the plane of the second top surface comprises 20.95 degrees and the angle extending between the plane of the first bottom surface and the plane of the second bottom surface comprises 20.95 degrees.

8. A conduit tray as defined in claim 1, wherein the first and second circumferential grooves of each of the plurality of cam rungs extends continuously on all sides of each of the elongated rung body member and further defines the inward boundary of each of the respective first and second cam sections.

9. A conduit tray as defined in claim 1, wherein each of the first and second E-beams further includes a secondary upward extending lip extending upward from a distal end portion of the lowest leg member toward the middle leg member and extending substantially the length of the lowest leg member, and wherein each of the plurality of cam rungs further includes a first auxiliary circumferential groove formed in the rung body member and located proximal to the first end and inward along the rung body from the first circumferential groove to contactingly engage the secondary lip of the first E-beam to further support the first end portion of the rung body member to the E-beam and a second auxiliary circumferential groove formed in the rung body member and located proximal to the second end and inward along the rung body from the second circumferential groove to contactingly engage the secondary tip of the second E-beam to further support the second end portion of the rung body member to the E-beam.

10. A conduit tray as defined in claim 1, further comprising a curvilinear shaped plate member defining a drop out, the drop out comprising:
a central flat portion of plate with a width substantially similar to the distance between the first circumferential groove and the second circumferential groove of a rung body member, the central flat portion comprising a plurality of holes spaced along its width;
a first end portion with a surface extending in a downward arc a first direction from the central flat portion with a width substantially similar to the width of the central flat portion, the curved first end portion comprising a curved plate, the curve being such that a distal end of the curved first end portion is in a plane substantially perpendicular to the plane of the central flat portion; and
a rung engaging portion of plate, the rung engaging portion located at a second end of the central flat portion opposite the curved first end portion, with a width substantially similar to the width of the central flat portion and including:
an orthogonal plate section extending from the central flat portion in a plane substantially perpendicular to the plane of the central flat portion and which has a height substantially similar to a height of the rungs,
a lower flat plate portion extending from the orthogonal plate section towards the curved first end portion in a direction substantially parallel to the central flat portion with a length longer than the length of the rungs, and
a generally triangular shaped end portion extending from the lower flat plate portion towards the central flat portion, having a surface which is parallel to the orthogonal plate section to form a rung grip, the distance between a face of the rung grip and the orthogonal plate section being substantially similar to the length of the rungs and the rung grip matingly engaging the rung body member to secure the drop out to the rung body member.

11. A brace to retain a cam body member, the brace comprising:
a brace member having an elongated web member defining a beam body;
a lowermost leg member being connected to, and extending substantially perpendicular to, a lower end portion of the beam body, extending substantially the length of the beam body;
an upward extending lip extending upward from a medial portion of the lowermost leg member, extending substantially the length of the lowermost leg member;
a middle leg member connected to, and extending substantially perpendicular to a medial portion of the beam body in a location above the lowermost leg members, extending substantially the length of the beam body, the middle leg member having a width less than a width of the lowermost leg members and extending in a substantially similar direction as lowermost leg members so that the extent of the middle leg member is substantially parallel to the lowermost leg member; and
a downward extending lip extending downward from a distal end portion of the middle leg member toward the lowermost leg member, extending substantially the length of the middle leg member, so that interstitial space located between surfaces of the upward extending lip and the downward extending lip, portions of the middle leg member, portions of the lowermost leg member, and portions of the beam body extending therebetween have a substantially C-shape extending substantially the length of the -beam body to thereby define a C-channel.

12. A brace as defined in claim 11, wherein the lowermost leg member further includes a portion extending beyond the upward extending lip to thereby define a lower ledge, the lower ledge having a plurality of slots formed in and extending downwardly from upper surfaces of the lower ledge and each spaced apart from another slot at preselected distances along the length of the lowermost leg.

13. A brace as defined in claim 11, further comprising a secondary upward extending lip extending upward from a distal end portion of the lowest leg member toward the middle leg member, extending substantially the length of the lowermost leg member.

14. A cam member to mate with a brace, the cam member comprising:
a cam body member having an end;
a circumferential groove formed in the cam body member and located proximal to the end to engage a portion of a brace;
an end portion to matingly position within a portion of the brace, extending inwardly from the end toward the rung body member to define a cam section and so that the end defines an outward boundary of the cam section, and the circumferential groove defines an inward boundary of the cam section, the cam section including a top end, a bottom end, a first side surface and a second side surface, the first side surface being opposite and substantially parallel to the second side surface, the bottom end comprising a plurality of surfaces on different planes and meeting the first side surface at an interior angle greater than 90 degrees, the top end comprising a plurality of surfaces on different planes and meeting the second side surface at an interior angle greater than 90 degrees.

15. A cam member as defined in claim 14, wherein:
the first side surface of each cam section is substantially similar in height to a height of the second side surface and a length of a portion of the top end which is perpendicular to the first side surface and second side surface is substantially similar in length to a length of a portion of the bottom end which is perpendicular to the first side surface and second side surface;
the plurality of top surfaces includes two top surfaces, a first top surface extending from the first side surface and being substantially perpendicular to the first side surface and the second side surface, and a second top surface extending from the first top surface to the second side surface, the second top surface being on a plane that is angled downward from the plane of the first top surface; and
the plurality of bottom surfaces includes two bottom surfaces, a first bottom surface extending from the second side surface and being substantially perpendicular to the first side surface and the second side surface, and a second bottom surface extending from the second bottom surface to the first side surface, the second bottom surface being on a plane that is angled upward from the plane of the first bottom surface.

16. A cam member as defined in claim 15, wherein the angle between the plane of the first top surface and the plane of the second top surface is in the range of 20.5 is 21.5 degrees and the angle between the plane of the first bottom surface and the plane of the second bottom surface is in the range of 20.5 is 21.5 degrees.

17. A cam member as defined in claim 16, wherein the angle between the plane of the first top surface and the plane of the second top surface is 20.95, degrees and the angle between the plane of the first bottom surface and the plane of the second bottom surface is 20.95 degrees.

18. A cam member as defined in claim 15, wherein the circumferential groove extends continuously on all sides of the cam body member.

19. A cam connector to matingly connect a member therein, the connector comprising:
a brace member having a brace body the brace member further including;
a lowermost leg member being connected to, extending substantially perpendicular to, and extending from a lower end portion of the brace body,
an upward extending lip extending upward from a medial portion of the lowermost leg member,
a middle leg member connected to, extending substantially perpendicular to, and extending from a medial portion of the brace body in a location above the lowermost leg member, extending in a substantially similar direction as lowermost leg member so that the extent of the middle leg member is substantially parallel to the lowermost leg member, and
a downward extending lip extending downward from a distal end portion of the middle leg member toward the lowermost leg member, so that interstitial space located between surfaces of the upward extending lip and the downward extending lip, portions of the middle leg member, portions of the lowermost leg member, and portions of the beam body extending therebetween have a substantially C-shape to thereby define a C-channel;
a cam member to mate with the brace member, the cam member comprising:
a cam body member having an end,
a circumferential groove formed in the cam body member and located proximal to the end to engage a portion of a brace,
an end portion to matingly position within a portion of the brace, extending inwardly from the end toward the rung body member to define a cam section and so that the end defines an outward boundary of the cam section, and the circumferential groove defines an inward boundary of the cam section, the cam section including a top end, a bottom end, a first side surface and a second side surface, the first side surface being opposite and substantially parallel to the second side surface, the bottom end comprising a plurality of surfaces on different planes and meeting the first side surface at an interior angle greater than 90 degrees, the top end comprising a plurality of surfaces on different planes and meeting the second side surface at an interior angle greater than 90 degrees, the cam section substantially filling an interstitial space within the C-channel of the brace, and portions of the top end, bottom end, first side surface and second side surface of the cam section contacting surfaces within the C-channel.

20. A cam connector as defined in claim 19, wherein the first side surface of the cam section is substantially similar in height to a height of the second side surface and a length of a portion of the top end which is perpendicular to the first side surface and second side surface is substantially similar in length to a length of a portion of the bottom end which is perpendicular to the first side surface and second side surface.

21. A cam connector as defined in claim 19, wherein:
the plurality of top surfaces of the cam section includes two top surfaces, a first top surface extending from the first side surface and being substantially perpendicular to the first side surface and the second side surface, and a second top surface extending from the first top surface to the second side surface, the second top surface being on a plane that is angled downward from the plane of the first top surface; and
the plurality of bottom surfaces of the cam section includes two bottom surfaces, a first bottom surface extending from the second side surface and being substantially perpendicular to the first side surface and the second side surface, and a second bottom surface extending from the second bottom surface to the first side surface, the second bottom surface being on a plane that is angled upward from the plane of the first bottom surface.

22. A cam connector as defined in claim 21, wherein the angle between the plane of the first top surface and the plane of the second top surface is in the range of 20.5 is 21.5 degrees and the angle between the plane of the first bottom surface and the plane of the second bottom surface is in the range of 20.5 is 21.5 degrees.

23. A cam connector as defined in claim 21, wherein the angle between the plane of the first top surface and the plane of the second top surface is 20.95 degrees and the angle between the plane of the first bottom surface and the plane of the second bottom surface is 20.95 degrees.

24. A cam connector as defined in claim 19, wherein:
the brace member further includes a secondary upward extending lip extending upward from a distal end portion of the lowest leg member toward the middle leg member; and
the cam member further includes a secondary circumferential groove formed in the cam body member located farther from the end than the circumferential groove, to engage the secondary lip of the lowest leg member to further secure the cam body member to brace member.

25. A cam connector as defined in claim 19, wherein the lowermost leg member further includes a portion extending inward of the upward extending lip to thereby define a lower ledge to provide additional support for the cam body member.

26. A brace and rung structure, the structure comprising:
a first brace member and a second brace member, the second brace member being positioned spaced apart and facing an opposite direction of the first brace member, the first and second brace members each having:
a web member defining a brace body,
a lowermost leg member connected to, extending substantially perpendicular to, and extending inwardly from a lower end portion of the brace body,
an upward extending lip extending upward from the lowermost leg member,
a middle leg member connected to, extending substantially perpendicular to, and extending inwardly from a medial portion of the brace body in a location above the lowermost leg member, and
a downward extending lip extending downward from a distal end portion of the middle leg member toward the lowermost leg member, so that interstitial space located between surfaces of the upward extending lip and the downward extending lip, portions of the middle leg member, portions of the lowermost leg member, and portions of the E-beam body extending therebetween have a substantially C-shape to thereby define a C-channel:
at least one cam rung connected to and extending between each of the brace members, each of the at least one cam rungs including:
an elongated rung body member;
a first end portion including a first end, a head member extending inwardly from the first end toward the rung body member to define a first cam section and so that the first end defines an outward boundary of the first cam section, and a first circumferential groove spaced apart from, proximal to the first end and the first cam section, formed in the rung body member, and defining an inward boundary of the first cam section, the first groove being positioned to contactingly engage the upper extending and downward extending lips of the C-channel of the first brace member, and
a second end portion including a second end positioned substantially opposite to the first end and extending inwardly from the second end toward the rung body member to define a second cam section and so that the second end defines an outward boundary of the second cam section, and a second circumferential groove spaced apart from, proximal to the second end and the second cam section, formed in the rung body member, and defining an inward boundary of the second cam section, the second groove being positioned to contactingly engage the upper extending and downward extending lips of the C-channel of the second brace member.

27. A brace and rung structure as defined in claim 26, wherein each of the can sections includes a top end, a bottom end, a first side surface and a second side surface, the first side surface being opposite and substantially parallel to the second side surface, the bottom end comprising a plurality of surfaces on different planes and meeting the first side surface at an interior angle greater than 90 degrees, the top end comprising a plurality of surfaces on different planes and meeting the second side surface at an interior angle greater than 90 degrees, the cam section substantially filling an interstitial space within the C-channel of the brace, and portions of the top end, bottom end, first side surface and second side surface of the cam section contacting surfaces within the C-channel.

28. A brace and rung structure as defined in claim 27, wherein each cam section has a first side surface height that is substantially similar in height to a height of the second side surface, and a length of a portion of the top end which is perpendicular to the first side surface and second side surface substantially similar in length to a length of a portion of the bottom end which is perpendicular to the first side surface and second side surface.

29. A method of assembling a rung interface, the method comprising:
providing a brace member, the brace member having a web portion defining a brace body, a lowermost leg member connected to, extending substantially perpendicular to, and extending inwardly from a lower end portion of the brace body, extending substantially the length of the brace body, an upward extending lip extending upward from a medial portion of the lowermost leg member, having an outward facing surface, and extending substantially the length of the lowermost leg member, a middle leg member connected to, extending substantially perpendicular to, and extending inwardly from the brace body in a location above the lowermost leg member, extending substantially the length of the brace body, the middle leg member having a width less than the width of the lowermost leg member and extending in a substantially similar direction as the lowermost leg member so that the extent of the middle leg member is substantially parallel to the extent of the lowermost leg member, and a downward extending lip extending downward from a distal end portion of the middle leg member toward the lowermost leg member, having an outward facing surface, and extending substantially the length of the middle leg member, so that interstitial space located between outward surfaces of the upward extending lip and the downward extending lip, portions of the middle leg member, portions of the lowermost leg member, and an inward facing portions of the brace body extending therebetween have a substantially C-shape, extending substantially the length of the brace member to thereby define a C-channel;
positioning an end portion of a rung body member between the downward extending lip and the upward extending lip within the C-channel such that an end surface of the rung body abuttingly contacts an inward facing portion of the brace body and the end portion of the body member is located within the C-channel in an unsupported position;
rotating the rung body member such that a circumferential groove formed in the rung body member and located proximal to a rung end of the rung body member matingly engages the downward extending lip and upward extending lip of the beam, the end portion of the rung body proximal to the rung end extending outwardly from the circumferential groove defining a cam section of the rung body such that the earn section of the rung body member is in a supported position within the C-channel;

30. A method as defined in claim 29, wherein:
the step of providing a brace further comprises the step of providing a second brace member positioned spaced apart and facing an opposite direction as the first brace member;
the step of positioning an end portion of a rung body member further comprises positioning a second end portion of the rung body member between the downward extending lip and the upward extending lip within the C-channel of the second brace member; and
the step of rotating the rung body member further comprises rotating the rung body such that the cam section of the rung body member is in a secured position and the second end portion of the rung body member is in a secured position within the second brace member.

31. A method as defined in claim 29, wherein the step of rotating the rung body member further comprises rotating the rung body member until the cam section of the rung body member substantially fills the interstitial space of the C-channel and a portion of a top end, a portion of a bottom end, a portion of a first side surface and a portion of a second side surface of the cam section, abuttingly contact surfaces within the C-channel.

32. A method as defined in claim 29, wherein the step of rotating the rung body member is performed with a separate tool.

33. A method as defined in claim 29, wherein the step of rotating the rung body member further comprises rotating the rung body 90 degrees.

34. A method as defined in claim 30, further comprising the steps of:
locating a rung engaging portion of a drop out over the rung body, the dropout comprising a central flat portion of plate, a first end portion with a surface extending in a downward arc in a first direction from the central flat portion, and a rung engaging portion being at a second end of the central flat portion opposite the curved first end portion; and
applying a linear and rotating force to the drop out to create an abutting contact between a face of a rung grip of the drop out and a bottom surface of the rung body member, the rung grip being located at the distal end of the rung engaging portion and having a generally triangular shape.
